(19) United States
(12) Patent Application Publication
(10) Pub. No.: US 2017/0357684 A1
(43) Pub. Date: Dec. 14, 2017

(54) Event Reporting

(71) Applicant: Ethan Horne, Bellville, TX (US)

(72) Inventor: Ethan Horne, Bellville, TX (US)

(21) Appl. No.: 15/361,536

(22) Filed: Nov. 28, 2016

Related U.S. Application Data
(60) Provisional application No. 62/349,325, filed on Jun. 13, 2016.

(51) Int. Cl. G06F 17/30

(52) U.S. Cl. CPC G06F 17/30368

(57) ABSTRACT

Various methods and apparatuses relating to event reporting are described. According to an example implementation, a processing system is operable to: capture an input time and an input date of an event; capture location information of the event; capture a severity of the event; capture weather information corresponding to the location information, the input time, and the input date; capture identification information of the processing system, a user of the processing system, or a combination thereof; and transmit a report to a database. The report comprises the input time, the input date, the location information, the severity, the weather information, and the identification information.

### CROSS-REFERENCE TO RELATED APPLICATIONS

This application claims priority to and the benefit of U.S. Provisional Application No. 62/349,325, titled “Odor Reporting System,” filed Jun. 13, 2016, the entire disclosure of which is hereby incorporated herein by reference.

### BACKGROUND OF THE DISCLOSURE

Various systems and utilities are utilized by the general public on a daily basis. One example of such systems and utilities is a wastewater collection and treatment system. Wastewater collection and treatment systems have been implemented in many areas of the world. Wastewater can be generated from many sources. It is treated to improve quality of water that is discharged out to the environment or reclaimed. Effective collection of wastewater is directed to minimizing inconvenience and odors that may be emitted by a collection system. Other systems and utilities can also incur various events.

### BRIEF DESCRIPTION OF THE DRAWINGS

The present disclosure is understood from the following detailed description when read with the accompanying figures. It is emphasized that various features are not drawn to scale. In fact, the dimensions of the various features may be arbitrarily increased or reduced for clarity of discussion.

FIG. 1 is a simplified schematic of a system that comprises a collection system and a corresponding data acquisition system.

FIG. 2 is a simplified schematic view of a wet well.

FIG. 3 is a simplified schematic view of a feeding station.

FIG. 4A is a simplified schematic view of a pressure monitor.

FIG. 4B is a simplified schematic view of a pressure monitor.

FIG. 5 is a simplified schematic view of an example, generic processing system.

FIGS. 6, 7, and 8 are simplified views of user interfaces of a software program executed by a processing system of a user device and as appearing on a screen of the user device.

FIGS. 9 and 10 are a process of operations for generating and storing an odor report.

FIG. 11 is a simplified view of a user interface of a software program executed by a processing system of a back-end terminal and as appearing on a screen of the back-end terminal.

FIG. 12 is a process of operations for reviewing, responding to, and/or invalidating an odor report.

FIG. 13 is an example database including some example objects that may be stored therein.

FIG. 14 is a simplified view of a user interface of a software program executed by a processing system of a back-end terminal and as appearing on a screen of the back-end terminal.

FIG. 15 is a process of operations for compiling and collating odor reports and/or other objects.

FIGS. 16, 17, and 18 are simplified views of user interfaces of a software program executed by a processing system of a user device and as appearing on a screen of the user device.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

Various example implementations are described herein in the context of event reporting, and/or data acquisition. In some examples, a software program can be executed on a user device, such as a mobile handheld device, to enable the user (e.g., any member of the public) of the device to report an event. In further examples, the software program may be configured to enable the user to report one type of event or may be configured to enable the user to report any of a plurality of types of events. In some examples, a data acquisition system can be implemented that may further include use of such a software program executed on a user device. The data acquisition system can further be implemented in conjunction with an operational system, such as a wastewater collection system or another system. A database can be implemented to store reports of events and other data that may be collected or used in the data acquisition system. One or more software programs can be executed on one or more terminals, such as a desktop or laptop computer, a tablet, or the like, for reviewing, responding to, and/or invalidating reports and for filtering, collating, and displaying information stored in the database. Various modifications can be made to example implementations described herein while remaining within the scope of the present disclosure.

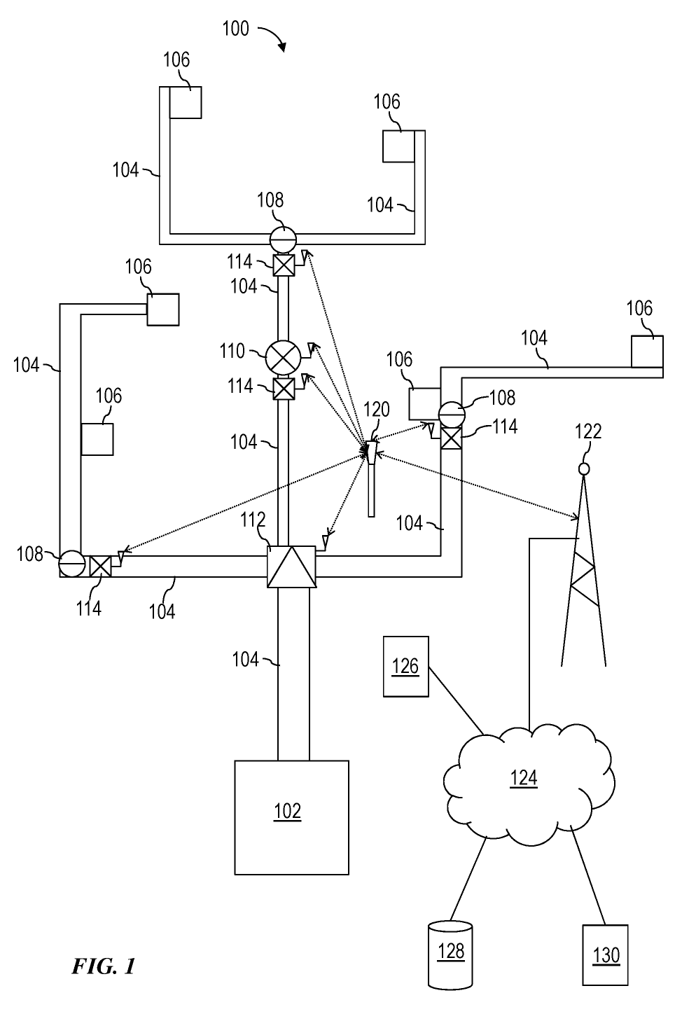

FIG. 1 depicts a simplified schematic of a system 100 that comprises a collection system through which wastewater is conveyed to a wastewater treatment facility 102, and that comprises a corresponding data acquisition system. The collection system includes a network of pipes 104 fluidly coupled together to convey wastewater to the wastewater treatment facility 102. The pipes 104 can be any size, e.g., 60 inch, 48 inch, etc., and in some examples, the pipes 104 can be any combination of the same and/or differing sizes throughout the collection system. The pipes 104 may also or instead be or include conduit, channels, or the like. The network of pipes 104 receives wastewater from a number of wastewater sources 106. Each of the wastewater sources 106 is fluidly coupled to the network of pipes 104. The wastewater sources 106 can be, for example, residential or commercial buildings, office complexes, consumer complexes, storm drains, and/or the like. Generally, the network of pipes 104 receives wastewater from the wastewater sources 106 and conveys the wastewater to the wastewater treatment facility 102, where the wastewater is treated and subsequently discharged to the environment or reclaimed.

Manholes 108 can be located in various positions throughout the collection system. Each of the manholes 108 can allow for physical access to the network of pipes 104 at the location of the respective manhole 108. For example, a manhole 108 can allow for maintenance personnel to physically enter the network of pipes 104 for maintenance, to take a sample of the wastewater in the network of pipes 104, etc.

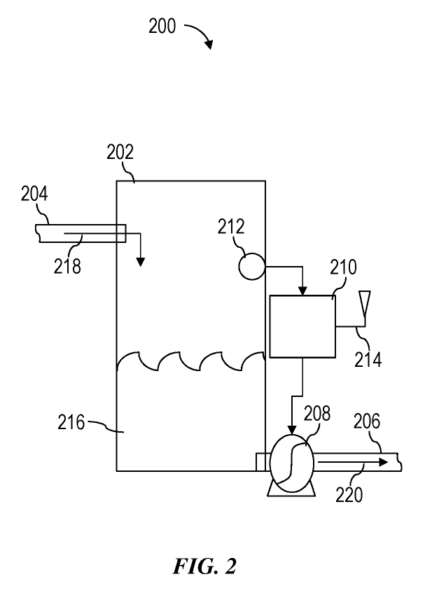

Each of the pipes 104 may be a force main and/or a gravity main. In a gravity main pipe, conveyance of wastewater is by gravity, e.g., the wastewater flow direction is towards a decline. In a force main pipe, conveyance of wastewater uses an applied force, such as by a pump, and the wastewater flow direction can be towards an incline. In a collection system that includes a force main pipe, a wet well 110 can be included to supply an applied force, such as is illustrated in FIG. 1. A wet well 110 can include a well and a pump, as described in more detail below with respect to FIG. 2. The well can receive wastewater from a pipe 104. When the level of wastewater in the well reaches a predetermined level as determined by a sensor and/or controller, the sensor and/or controller can initiate the pump to start pumping wastewater from the well to a force main pipe 104. The controller of the wet well 110 has a transceiver that enables communication, such as wireless communication, and additional details of an example wet well, including a sensor, controller, and transceiver, are illustrated in and described with respect to FIG. 2 below. The network of pipes 104 can include any combination of force main and gravity main pipes, and in some instances, the network of pipes 104 may not include any force main pipes or any gravity main pipes. The collection system can include any number of wet wells 110, which can be at any location in the collection system.

Wastewater can include many types of fluids, chemicals, and organisms. For example, wastewater can include hydrogen sulfide (H₂S) and bacteria. When hydrogen sulfide is released in gaseous form from wastewater, the hydrogen sulfide can have a foul odor. Hydrogen sulfide can be released at greater rates at locations of turbulence of the wastewater in the collection system. Some locations of turbulence of the wastewater in the collection system can be at a wet well 110 where wastewater is collected (e.g., dropped) into a well of a wet well and subsequently pumped out, at a transition point in a pipe 104 from a force main to a gravity main, at an intersection of pipes 104 where different flow directions of wastewater intermingle, at a change in flow speed, at bends in pipes, at changes in flow angle, or others.

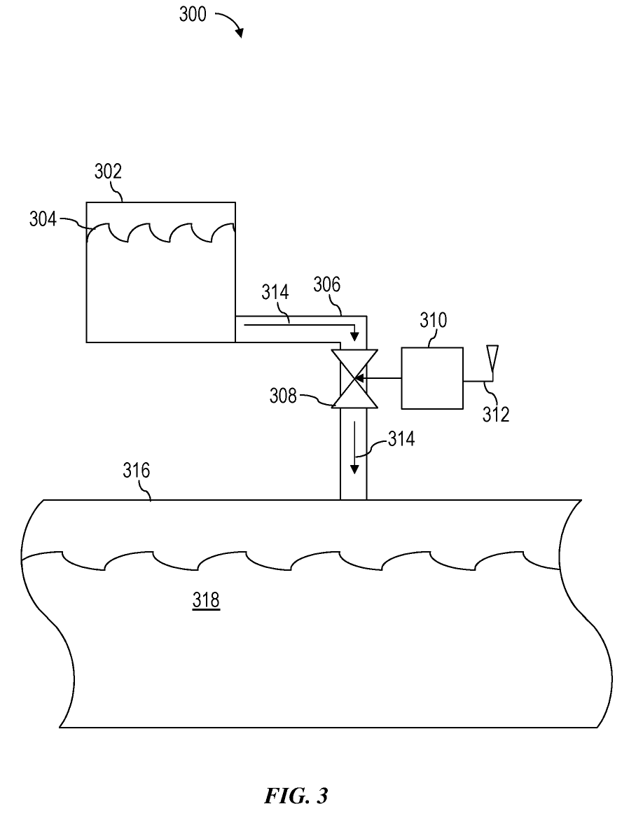

The collection system includes a feeding station 112 that releases a treatment chemical into the network of pipes 104. The treatment chemical, in some instances, can be capable of reacting with and oxidizing hydrogen sulfide in the wastewater. The treatment chemical, in some instances, can be capable of supplying oxygen for a biochemical oxygen demand (BOD) in the wastewater. The feeding station 112 includes a controller and a valve, metering pump, or the like that is controlled by the controller for dispensing the treatment chemical. The controller of the feeding station 112 also has a transceiver that enables communication, such as wireless communication. Additional details of an example feeding station, including a valve (or metering pump or the like), controller, and transceiver, are illustrated in and described with respect to FIG. 3. The collection system can include any number of feeding stations 112, which can be at any location in the collection system.

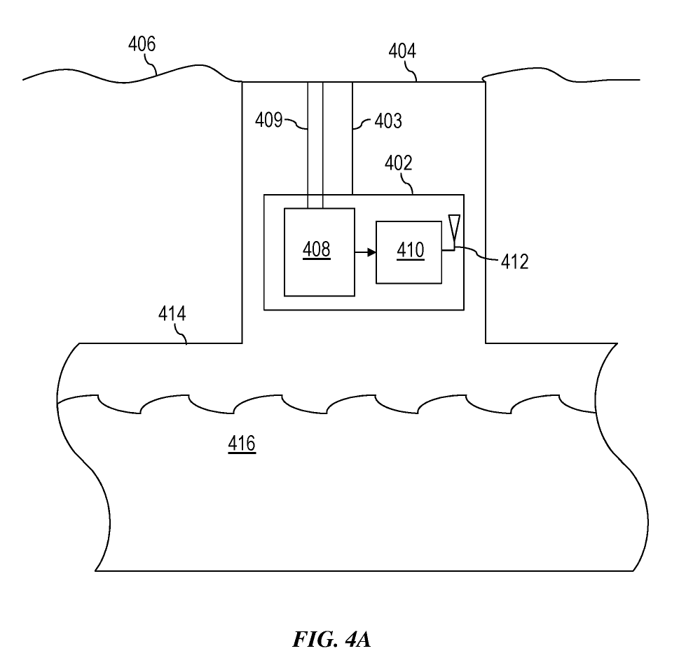

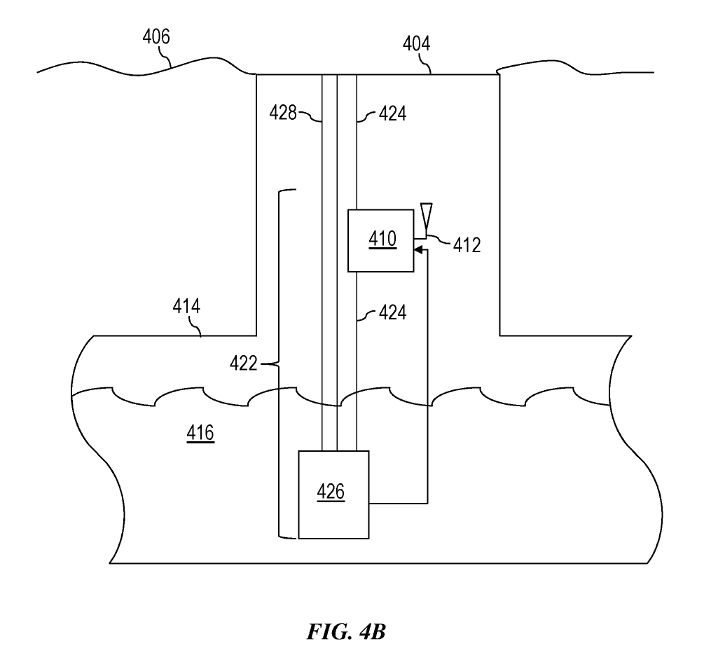

The collection system also includes pressure monitors 114. The pressure monitors 114 can be located at various locations throughout the network of pipes 104 of the collection system. Each of the pressure monitors 114 is configured to monitor pressure of gas and/or wastewater at the respective location of the pressure monitor 114. For example, some pressure monitors can monitor a pressure of gas (e.g., a head space), and other pressure monitors can monitor a pressure of the wastewater. In some examples, individual pressure monitors can monitor respective pressures of gas and wastewater. Each pressure monitor 114 includes at least one pressure transducer and a controller communicatively coupled to the pressure transducer. The controller of the pressure monitor 114 also has a transceiver that enables communication, such as wireless communication. Additional details of example pressure monitors, such as including a pressure transducer, a controller, and a transceiver, are illustrated in and described with respect to FIGS. 4A and 4B. The collection system can include any number of pressure monitors 114, which can be at any location in the collection system. In some examples, the pressure monitors 114 are located at manholes 108 as is illustrated in the collection system of FIG. 1, such as for convenience, although in other examples, the pressure monitors can be located in other locations.

The data acquisition system includes a relay station 120. The relay station 120 is communicatively coupled to the respective transceivers and controllers of the wet well 110, the feeding station 112, and the pressure monitors 114 and is further communicatively coupled to a network 124 through a base station 122. The relay station 120 can communicate with each controller of the wet well 110, feeding station 112, and pressure monitors 114 using wireless communication. In some examples, the communication between the relay station 120 and the controllers of the wet well 110, feeding station 112, and pressure monitors 114 can instead be or also include wired communications. The relay station 120 can be located at any position, and in some examples, is located within a predetermined distance range of each of the wet well 110, feeding station 112, and pressure monitors 114, such as within 1 mile. The relay station 120 can be located at the location of the feeding station 112 or another station (including a wet well) for convenience, for example. The relay station 120 can communicate with the base station 122 using wireless communication, such as through a cellular network implementing any wireless communication standard. In some examples, the communication between the relay station 120 and the base station 122 may instead be or also include wired communication, such as through optical fiber or the like.

The base station 122 is communicatively coupled to a network 124, which may include the Internet, a wide area network (WAN), a local area network (LAN), the like, or a combination thereof. A user device 126, such as a handheld mobile device like an Apple iPhone™, Samsung Galaxy™, or the like, is communicatively coupled to the network 124. A database device 128, such as a server implementing a database in memory, is communicatively coupled to the network 124. A back-end device 130, such as a desktop or laptop computer, a tablet, handheld device, or the like, is communicatively coupled to the network 124. The communications between the network 124 and the user device 126, database device 128, and back-end device 130 may include any wired and/or wireless communication.

The controllers (e.g., using the respective transceivers) of the wet well 110, feeding station 112, and pressure monitors 114 transmit information regarding the respective operation and/or detection of the wet well 110, feeding station 112, and pressure monitors 114. This information is transmitted from the controllers of the wet well 110, feeding station 112, and pressure monitors 114 to the relay station 120, and the information is then transmitted from the relay station 120, through the base station 122 and network 124 to the database device 128, where the information is stored in the database. For example, the controller of the wet well 110 can cache and communicate the times at which the pump of the wet well is pumping, such as by caching and communicating start times and ending times. The controller of the feeding station 112 can store and communicate information concerning field values about dispensing of chemicals into the wastewater, and further may receive and store information for future scheduled dispensing of the chemicals. The controller of the pressure monitor 114 can cache and transmit time stamped pressure readings. This information can be transmitted, e.g., through the network 124 to the database device 128, where the information is stored in the database.

In some examples, the information can be transmitted from the controllers (e.g., using the respective transceivers) of the wet well 110, feeding station 112, and pressure monitors 114 substantially instantaneously following the event that triggers the generation of the information being transmitted. For example, at a wet well, information about the pumping start time and end time (or a duration of pumping) can be transmitted by the controller and transceiver of the wet well substantially instantaneously following the conclusion of the pumping. As a further example, at a pressure monitor, pressures measured by the pressure monitor can be transmitted by the controller and transceiver of the pressure monitor substantially instantaneously following the measurement. As an example, processing by the controller and/or transceiver, including any temporary caching, of data in preparation of transmission following the event that triggered the generation of the data can be included within a substantially instantaneous transmission. By information being transmitted in such a manner, and by the information being received at and stored in the database device 128, information stored in the database of the database device 128 may be current and up-to-date for analytics performed on the data, such as described below. In other examples, information can be transmitted from the controllers of the wet well 110, feeding station 112, and pressure monitors 114 on set, periodic schedules and/or techniques where transmission is not substantially instantaneously, for example.

The user device 126 can be a device of any person of the general public, for example. The user device 126 has a software program comprising program instructions stored on memory that are executable by a processing system of the user device 126. The software program, when executed by the user device 126, allows the user of the user device 126 to report an event, such as a foul odor. The software program can be a web browser or other stand-alone application that enables a user to generate and transmit a report. The report is transmitted from the user device 126 through the network 124 to the database device 128, where the report is stored in the database. Additional details of an example software program on a user device are described below.

The back-end device 130 can be a device of an operator of the system 100, such as a municipality, for example. The back-end device 130 has a software program comprising program instructions stored on memory that are executable by a processing system of the back-end device 130. The software program can be a web browser or other stand-alone application that enables a user to query the database of the database device 128 and to display the information returned from the database. The software program on the back-end device 130 can also be used to review, respond to, and/or invalidate reports stored in the database, although in some examples, such a software program can be on a different device. Additional details of one or more example software program on a back-end device is described below.

The collection system and data acquisition system depicted in and described with respect to FIG. 1 are used as an example herein. Other example collection and/or data acquisition systems can include any configuration of pipes, wastewater sources, manholes, wet wells, feeding stations, pressure monitors, and communication systems, among others. Some example collection systems can include additional components not depicted in the collection system and/or data acquisition system of FIG. 1, and/or may omit some components depicted in the collection system and/or data acquisition system of FIG. 1. Further, different operation systems with different data acquisition systems may be implemented within the scope of the present disclosure.

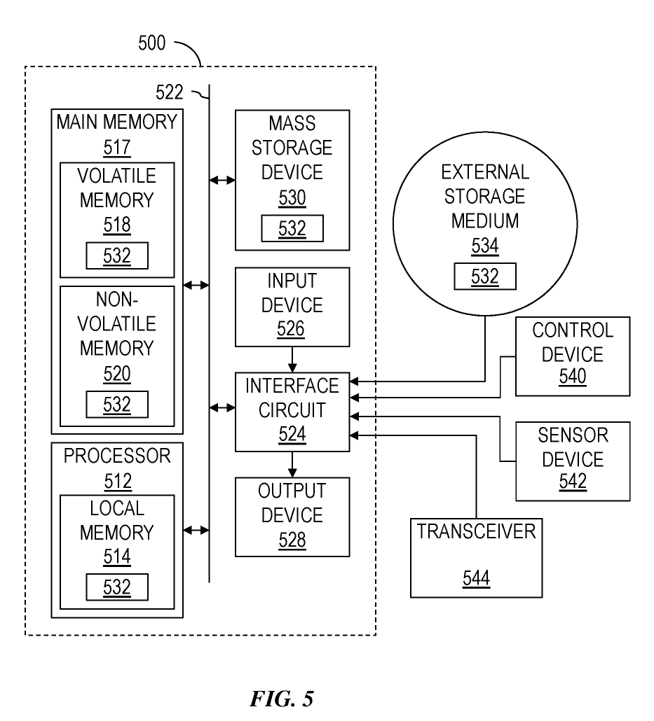

FIG. 2 illustrates a simplified schematic view of a wet well 200, which may be an example of the wet well 110 in the collection system of FIG. 1. The wet well 200 includes a well 202 having an inlet 204 and an outlet 206 with a pump 208. The inlet 204 is fluidly coupled to the well 202 at an upper portion of the well 202. In other examples, an inlet can be fluidly coupled to the well 202 at different locations, such as a lower portion, a position below an expected wastewater level, etc. The inlet 204 may be a pipe in a collection system, such as a pipe 104 in the collection system of FIG. 1, which may further be a force main or a gravity main. The outlet 206 is fluidly coupled to the well 202 at a lower portion of the well 202. The outlet 206 can be a pipe in a collection system, such as a pipe 104 in the collection system of FIG. 1, which may further be a force main. The pump 208 can be any type of pump, including an axial flow pump, a radial flow pump, a mixed flow pump, and other example pumps. The wet well 200 also includes a sensor 212 in the well 202. In the illustrated example, the sensor 212 is communicatively coupled to a controller 210, which is further communicatively coupled to the pump 208. In other examples, the sensor 212 may be communicatively coupled to the pump 208 and not the controller 210, and the controller 210 is communicatively coupled to the pump 208. The sensor 212 can be any type of sensor, including, for example, an ultrasonic transducer, a submersible pressure sensor, a bubbler, a point level float, a conductance sensor, or the like. The controller 210 has a transceiver 214 for communicating, e.g., to a database device, like the database device 128 through the relay station 120, base station 122, and network 124 in FIG. 1. The controller 210 and the transceiver 214 can be a processing system with a transceiver, such as described below with respect to FIG. 5.

In operation, the well 202 receives wastewater 216 by a flow 218 through the inlet 204. Wastewater 216 is collected in the well 202 until the wastewater 216 in the well 202 reaches a threshold level, at which level the sensor 212 and/or controller 210 determine that the wastewater has reached the threshold level. In the illustrated example, when the sensor 212 and/or controller 210 determine that the wastewater has reached the threshold level, the controller 210 initiates the pump 208 to begin pumping wastewater 216 from the well 202 out the outlet 206, as indicated by flow 220. In other examples, the sensor 212 can determine that the wastewater has reached the threshold level and can initiate the pump 208 to begin pumping wastewater 216 from the well 202 out the outlet 206. In such examples, the controller 210 can determine pumping information based on control signals sent to the pump 208 from the controller 210 and/or based on signals (e.g., pump on/off signals) received by the controller 210 from the pump 208. The controller 210 can cache in memory and/or transmit using the transceiver 214 pumping information, such as to the database device 128 through the network 124, base station 122, and relay station 120 in FIG. 1, which may further be substantially instantaneously following the pumping or not substantially instantaneously following the pumping. The pumping information can be or include a pumping start time and end time, a pumping start time and pumping duration, a combination thereof, or the like.

FIG. 3 illustrates a simplified schematic view of a feeding station 300, which may be an example of the feeding station 112 in the collection system of FIG. 1. The feeding station 300 includes a well 302 with an outlet 306. The outlet 306 is fluidly coupled to the well 302 proximate a bottom portion of the well 302, and may be a pipe, conduit, channel, or the like. A control valve 308 is mechanically coupled to the outlet 306 for controlling a flow through the outlet 306 from the well 302. In some examples, a metering pump may be used instead of or with the control valve 308. The control valve 308 is controlled by a controller 310. The controller 310 has a transceiver 312 for communicating, e.g., to a database device, like the database device 128 through the relay station 120, base station 122, and network 124 in FIG. 1. The controller 310 and the transceiver 312 can be a processing system with a transceiver, such as described below with respect to FIG. 5. The outlet 306 is fluidly coupled to a pipe 316 of a collection system through which wastewater 318 is conveyed. The pipe 316 can be any size, and in some examples, may also or instead be or include a conduit, a channel, or the like. In some examples, the outlet can be fluidly coupled to a well of a wet well or another component in the collection system, for example.

Treatment chemicals 304 are stored in the well 302 and may be released 314 from the well 302 through the outlet 306 under the control of the control valve 308. When treatment chemical 304 is released 314 into the wastewater in the pipe 316, chemical reactions between the treatment chemical 304 and components of the wastewater may occur. What reactions occur and behavior of the reactions can differ in the wastewater 318 depending on time, for example.

The controller 310 controls the operation of the control valve 308 to thereby control the release 314 of the treatment chemical 304 from the well 302 through the outlet 306 into the wastewater 318 in the pipe 316. The controller 310 can implement a program schedule that controls how the treatment chemical 304 is released 314, such as by controlling whether the release 314 is a discrete, instantaneous batch release, a continuous release, or a combination thereof; the rate of release; the period of a schedule of releases; or the like. The controller 310 has a transceiver 312 for communications. The controller 310 can receive a program schedule, or a modification to a program schedule, using the transceiver 312, such as by a communication transmitted from the database device 128 through the network 124, base station 122, and relay station 120 in FIG. 1. Similarly, the controller 310 can transmit actual release information using the transceiver 312, such as by a communication transmitted to the database device 128 through the network 124, base station 122, and relay station 120 in FIG. 1, which may further be substantially instantaneously following the release or not substantially instantaneously following the release.

FIG. 4A illustrates a simplified schematic view of a pressure monitor 402, which may be an example of the pressure monitor 114 in the collection system of FIG. 1. The pressure monitor 402 is illustrated as being suspended in a manhole 404 extending from ground surface level 406 to a pipe 414, through which wastewater 416 flows, of a collection system, such as in a manhole 108 in the collection system of FIG. 1. In some examples, a pressure monitor 402 can be located in other locations in a collection system. As illustrated, the pressure monitor 402 is suspended by a suspension 403, such as by a wire, chain, the like, or a combination thereof, from a cover of the manhole 404. In other examples, a pressure monitor may be exterior to the collection system (e.g., mounted on an outer surface of a cover of a manhole) and be in fluid communication with the collection system to detect a gas pressure of the collection system (e.g., by a conduit penetrating the cover of the manhole to fluidly couple the pressure monitor to a gas in the collection system). The pressure monitor 402 can be used to measure a pressure of gas in the collection system, which may be referred to as a head space.

The pressure monitor 402 includes one or more sensor transducer 408 and a controller 410 having a transceiver 412. A conduit 409 is fluidly coupled to the sensor transducer 408 and penetrates a cover of the manhole 404 such that a gas of the external atmosphere at ground surface level 406 is fluidly coupled to the sensor transducer 408. The sensor transducer 408 detects a gas pressure in the collection system at the location of the pressure monitor 402, a gas pressure of the external atmosphere at ground surface level 406, and/or a differential pressure between the gas pressure in the collection system and the gas pressure of the external atmosphere. The sensor transducer 408 communicates a signal representative of the detected gas pressure(s) to the controller 410. The controller 410 can cache in memory and/or transmit using the transceiver 412 the gas pressure information, such as to the database device 128 through the network 124, base station 122, and relay station 120 in FIG. 1, which may further be substantially instantaneously following the measurement or not substantially instantaneously following the measurement. The gas pressure information can be or include a pressure monitoring time, detected gas pressure(s), a combination thereof, or the like. The controller 410 and the transceiver 412 can be a processing system with a transceiver, such as described below with respect to FIG. 5.

FIG. 4B illustrates a simplified schematic view of a pressure monitor 422, which may be an example of the pressure monitor 114 in the collection system of FIG. 1. The pressure monitor 422 is illustrated as being suspended in a manhole 404 extending from ground surface level 406 to a pipe 414, through which wastewater 416 flows, of a collection system, such as in a manhole 108 in the collection system of FIG. 1. In some examples, a pressure monitor 422 can be located in other locations in a collection system. As illustrated, the pressure monitor 422 is suspended by a suspension 424, such as by a wire, chain, the like, or a combination thereof, from a cover of the manhole 404. The pressure monitor 422 can be used to measure a pressure of wastewater 416 in the collection system, which may be used to determine a level of the wastewater 416.

The pressure monitor 422 includes one or more sensor transducer 426 and a controller 410 having a transceiver 412. A conduit 428 is fluidly coupled to the sensor transducer 426 and penetrates a cover of the manhole 404 such that a gas of the external atmosphere at ground surface level 406 is fluidly coupled to the sensor transducer 426. The sensor transducer 426 is submersed in the wastewater 416 and detects a pressure of the wastewater 416 in the collection system at the location of the pressure monitor 422 and a gas pressure of the external atmosphere, which can be used to determine (e.g., by the controller 410) a level of the wastewater 416 in the pipe 414. Other types of sensors and/or techniques for determining the level of the wastewater 416 may be used in other examples. The sensor transducer 408 communicates a signal representative of the detected level to the controller 410. The controller 410 can cache in memory and/or transmit using the transceiver 412 the level information, such as to the database device 128 through the network 124, base station 122, and relay station 120 in FIG. 1, which may further be substantially instantaneously following the measurement or not substantially instantaneously following the measurement. The controller 410 and the transceiver 412 can be a processing system with a transceiver, such as described below with respect to FIG. 5.

FIG. 5 is a simplified schematic view of an example, generic processing system 500. The processing system 500 may execute machine-readable instructions to implement at least a portion of one or more software program for implementing various functions, such as operability described herein. The processing system 500 may be implemented in each of the controllers 210, 310, 410 of wet well 200, the feeding station 300, and pressure monitor 402 of FIGS. 2-4B, respectively, as described herein. Additionally, the processing system 500 may be implemented in each of the user device 126, database device 128, and back-end device 130 in the system 100 of FIG. 1.

The processing system 500 may be or comprise, for example, one or more processors, controllers, special-purpose computing devices, and/or other types of computing devices. The processing system 500 comprises a processor 512 such as, for example, a general-purpose programmable processor. The processor 512 may comprise a local memory 514, and may execute program code instructions 532 stored in the local memory 514 and/or in another memory device. The processor 512 may execute, among other things, machine-readable instructions or programs to implement various methods, processes, operations, and/or functionality described herein. The processor 512 may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor 512 include one or more INTEL microprocessors, microcontrollers from the ARM and/or PICO families of microcontrollers, embedded soft/hard processors in one or more FPGAs, etc.

The processor 512 may be in communication with a main memory 517, such as via a bus 522 and/or other communication means. The main memory 517 may comprise a volatile memory 518 and a non-volatile memory 520. The volatile memory 518 may be, comprise, or be implemented by a tangible, non-transitory storage medium, such as random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 520 may be, comprise, or be implemented by a tangible, non-transitory storage medium, such as read-only memory, flash memory and/or other types of memory devices. One or more memory controllers (not shown) may control access to the volatile memory 518 and/or the non-volatile memory 520.

The processing system 500 may also comprise a mass storage device 530 for storing machine-readable instructions and data. The mass storage device 530 may be in communication with the processor 512, such as via the bus 522. The mass storage device 530 may be or comprise a tangible, non-transitory storage medium, such as a floppy disk drive, a hard disk drive, a compact disk (CD) drive, and/or digital versatile disk (DVD) drive, among other examples. The program code instructions 532 may be stored in the mass storage device 530, the volatile memory 518, the non-volatile memory 520, the local memory 514, and/or on a removable storage medium, such as a CD or DVD.

The processing system 500 may also comprise one or more interface circuit 524. The one or more interface circuit 524 is in communication with the processor 512, such as via bus 522. The interface circuit 524 may be, comprise, or be implemented by various types of standard interfaces, such as an Ethernet interface, a universal serial bus (USB), a third generation input/output (3GIO) interface, a wireless interface, and/or a cellular interface, among other examples. The interface circuit 524 may also comprise a graphics driver card. The interface circuit 524 may also comprise a communication device such as a modem or network interface card to facilitate exchange of data with external computing devices via a network, such as via Ethernet connection, digital subscriber line (DSL), telephone line, coaxial cable, cellular telephone system, and/or satellite, among other examples.

One or more input devices 526 may be connected to the interface circuit 524. One or more of the input devices 526 may permit a user to enter data and/or commands for utilization by the processor 512. Each input device 526 may be, comprise, or be implemented by a keyboard, a mouse, a touchscreen, a track-pad, a trackball, an image/code scanner, and/or a voice recognition system, among other examples.

One or more output devices 528 may also be connected to the interface circuit 524. One or more of the output device 528 may be, comprise, or be implemented by a display device, such as a liquid crystal display (LCD), a light-emitting diode (LED) display, and/or a cathode ray tube (CRT) display, among other examples. One or more of the output devices 528 may also or instead be, comprise, or be implemented by a printer, speaker, and/or other examples.

One or more external storage medium 534 may be connected to the interface circuit 524. The external storage medium 534 may be or comprise a tangible, non-transitory storage medium, such as a hard disk, magnetic tape, magneto-optical drives, optical disc, solid state memory, and/or the like.

The processing system 500 is operable to store and execute program code instructions that implement a software program. The program code instructions 532 can be received, for example, through the interface circuit 524 by a wired or wireless connection and may be stored in any of, for example, volatile memory 518, non-volatile memory 520, mass storage device 530, and/or external storage medium 534. The processor 512 may access the program code instructions from memory and execute the program code instructions to implement a software program.

The modules and/or other components of the processing system 500 may be implemented in accordance with hardware (such as in one or more integrated circuit chips, such as an ASIC), or may be implemented as software or firmware for execution by a processor. In the case of firmware or software, the implementation can be provided as a computer program product including a computer readable medium or storage structure containing computer program code (i.e., software or firmware) for execution by the processor. Additionally, the processing system 500 may be implemented by multiple separate components and/or devices, such as in a distributed computing system.

The interface circuit 524 is also connected to an external control device 540, an external sensor device 542, and an external transceiver 544, as a general illustration. The presence or absence of such devices may depend on an application in which the processing system 500 is used and/or the functionality of the processing system 500. For example, if communication functionality of an external transceiver is incorporated into, e.g., the interface circuit 524, the external transceiver 544 may be omitted. In the context of the processing system 500 being implemented as the controller 210 of the wet well 200 of FIG. 2, the sensor device 542 can be the sensor 212, and the control device 540 can be the pump 208. In the context of the processing system 500 being implemented as the controller 310 of the feeding station 300 of FIG. 3, the control device 540 can be the control valve 308, and in some instances, the sensor device 542 may be omitted. In the context of the processing system 500 being implemented as the controller 410 of the pressure monitor 402, 422 of FIGS. 4A and 4B, the sensor device 542 can be the sensor transducer 408, 426, and in some instances, the control device 540 may be omitted. In some examples, the interface circuit 524 includes the functionality of the external transceiver 544 such that the external transceiver 544 may be omitted.

In the context of the processing system 500 being implemented in the user device 126, database device 128, and back-end device 130 of FIG. 1., in some examples, the external control device 540, external sensor device 542, and external transceiver 544 may be omitted. In some examples, the user device 126 is a mobile handheld device, such as an Apple iPhone™ or iPad™, a Samsung Galaxy™, Note™, or Tab™, or the like, implementing a processing system 500, and in such examples, the interface circuit 524 may implement wireless communication, such as by cellular communication and/or a data network-based communication, such as Wi-Fi. In some examples, the database device 128 can be a server implementing a processing system 500 that maintains a database in memory, such as main memory 517, mass storage device 530, and/or external storage medium 534, and the interface circuit 524 may implement wired communication, such as Ethernet, fiber, or the like. In some examples, the back-end device 130 can be a laptop or desktop computer, a tablet, a mobile handheld device, or the like, implementing a processing system 500, and in such examples, the interface circuit 524 may implement wired and/or wireless communication, such as by cellular communication and/or a data network-based communication, such as Wi-Fi and/or Ethernet. Other techniques and modes of communication, such as by wired, wireless, or a combination thereof, by the user device 126, database device 128, and back-end device 130 are within the scope of the present disclosure.

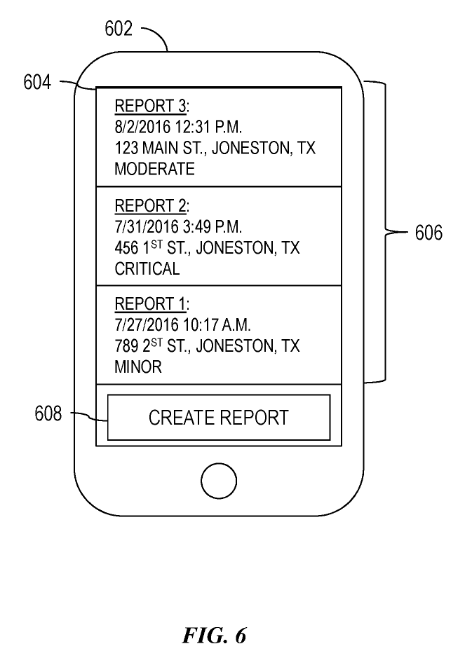

FIGS. 6-8 are simplified views of user interfaces 604, 704, 804, respectively, of a software program executed by a processing system of a user device 602 and as appearing on a screen (which may be a touchscreen) of the user device 602. The user device 602 may be, for example, the user device 126 in FIG. 1. The software program may enable the generation of an odor report.

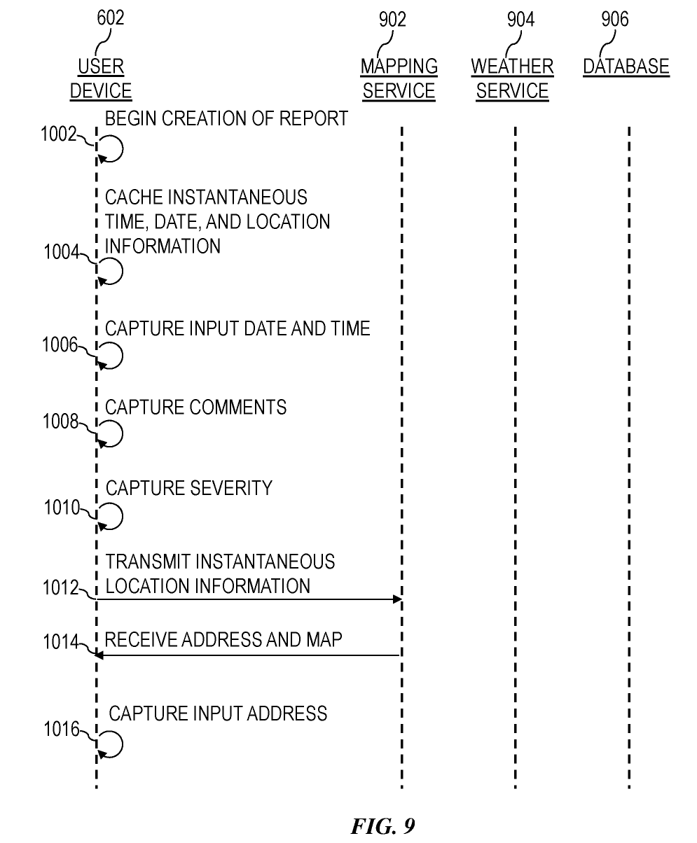

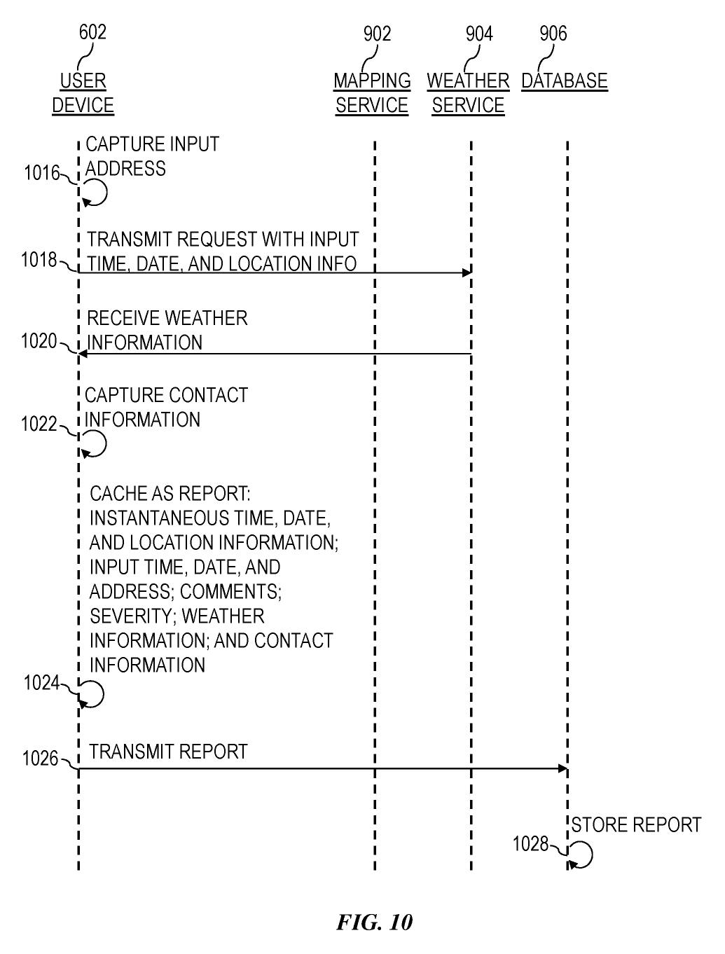

FIGS. 9-10 are a process of operations for generating and storing an odor report. The process includes operations performed by respective processing systems implementing one or more software program operating at the user device 602, a mapping service 902, a weather service 904, and a database 906 (e.g., the database maintained by the database device 128 in FIG. 1). Various modifications to the user interfaces 604, 704, 804 can be made, such as by including more or less information or functionality, while remaining within the scope of the present disclosure. Additionally, various modifications may be made to the process and/or operations therein while remaining within the scope of the present disclosure. For example, the process may include fewer or more operations, and may include performing various operations in a different order and/or in parallel. Communications between various devices, such as between the user device 602 and each of respective devices (e.g., server devices) operating the mapping service 902, weather service 904, and database 906 can be by any communication technique, including wired and/or wireless communications, and may include routing communications through various components, such as may be present in a network like network 124 in FIG. 1.

The software program operating on the user device 602 may be a stand-alone application, a web-based application, or the like. In some examples, the software program may be made available for download by one or more member of the general public as a stand-alone application through an application repository, such as the Apple App Store, Android Play Store, or the like. Other techniques for providing the software program are within the scope of the present disclosure.

In the illustrated example user interface 604 of FIG. 6, when the software program begins operating, the user interface 604 may appear on the screen, such as a touch screen, of the user device 602. In this example, a list 606 of recent reports created using the software program on the user device 602 is shown by the user interface 604 on the screen. The reports shown on the screen may be locally cached in memory of the user device 602. Any number of reports may be cached and/or listed. In some examples, if more reports are listed than there is available space on the screen, the software program may allow for scrolling through the list 606, such as by swiping up or down using a touch screen. In some examples, reports that are stored on a remote database, as will be described in further detail below, that are created using the software program on the user device 602, and that have been overwritten in the cache on the user device 602, for example, may be retrieved from the database when a user scrolls to the end of the list 606. The retrieved reports can be added to the list 606 to regenerate the list 606, which is displayed on the user interface 604.

In the illustrated example, details of each report on the list 606 are shown on the list by the user interface 604 on the screen. For example, in FIG. 6, each report has a date, time, location, and odor severity. In some examples, some details of each report may not be shown in the user interface at start-up. In some examples, a user may be able to select a report through the user interface 604, such as by clicking or tapping on the touch screen, which can provide another user interface on the screen that identifies one or more additional detail of the report to the user.

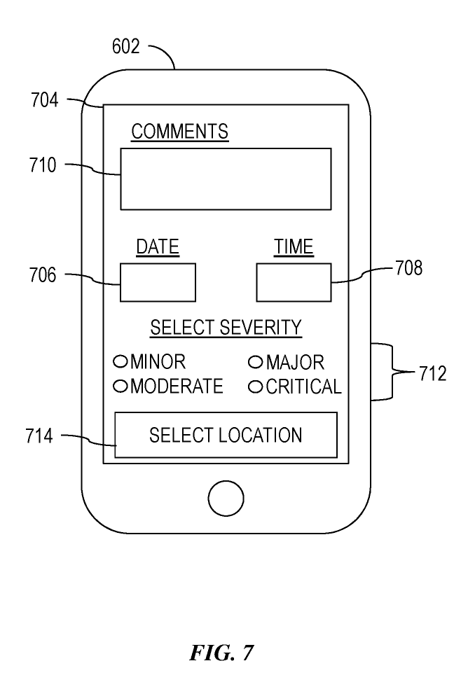

Further in the illustrated example, the user interface 604 includes a navigation button 608 for creating a new report. The user can select the navigation button 608, such as by clicking or tapping on the navigation button 608, to indicate to the software program to begin the creation of a report, as shown at operation 1002 in FIG. 9. When the navigation button 608 is selected, the software program proceeds to display a different user interface 704 on the user device 602, as shown in FIG. 7.

Additionally, when the navigation button 608 is selected, the software program captures and caches the instantaneous time, date, and location information, as shown in operation 1004 of FIG. 9, if such information is made available by the user device 602. For example, the user device 602 may include in its processing system a module that provides the instantaneous time and date, which may be synchronized to a given clock through a synchronization service, through an application program interface (API). The software program can access the instantaneous time and date by accessing the API, and once accessed, the software program can cache the instantaneous time and date. Similarly, the user device 602 may include in its processing system a module that provides location information, such as a GPS position, through another API. The software program can access the instantaneous location information by accessing the API, and once accessed, the software program can cache the instantaneous location information.

The user interface 704 of FIG. 7 includes a date field 706 and a time field 708. The software program may automatically populate the date field 706 and the time field 708 with the instantaneous date and time that was previously cached, if available. In some examples, if the date and time was not available, the date field 706 and time field 708 may be populated with a predefined, arbitrary date and time, respectively, to provide guidance to the user of the format for data input. In some examples, the user may manually alter and/or enter the date and time in the date field 706 and the time field 708, respectively. For example, when the user selects, such as by clicking or tapping, the date field 706, a virtual keyboard can appear on the user interface 704 for the user to use to type in the date in the date field 706; up/down arrows can appear to increment and decrement the displayed date in the date field 706; a drop-down calendar can appear for the user to select the appropriate date to be displayed in the date field 706; a scrolling list can appear for the user to drag months, days, and years to select the appropriate date to be displayed in the date field 706; or the like. Similarly, when the user selects, such as by clicking or tapping, the time field 708, a virtual keyboard can appear on the user interface 704 for the user to use to type in the time in the time field 708; up/down arrows can appear to increment and decrement the displayed time in the time field 708; a scrolling list can appear for the user to drag hours, minutes, and a.m./p.m. to select the appropriate time to be displayed in the time field 708; or the like. Hence, as shown in operation 1006 in FIG. 9, the input time and date is captured, which may or may not be the instantaneous time and date. By automatically capturing the time and date when the creation of the report begins, an accurate time stamp for the report may be obtained for a report created immediately when circumstances arise leading to the report, and by allowing for altering and/or entering the date and time, a user can delay reporting an incident to a more convenient time.

The user interface 704 further includes a comments field 710. The user can enter comments, such as additional information relevant to the report, in the comments field 710. The user may choose to not enter any comments in the comments field 710, and in some examples, the comments field 710 can be omitted. As shown in operation 1008 in FIG. 9, comments are captured.

The user interface 704 also includes a severity list 712 with radial buttons used to select from the options in the severity list 712. In the illustrate example, the severity list 712 includes as options “MINOR”, “MODERATE”, “MAJOR”, and “CRITICAL”. In some examples, different or more or fewer options may be included. The radial buttons allow the user to select, such as by clicking or tapping, a radial button corresponding to an appropriate severity option that corresponds with the odor that the user is reporting. Hence, a severity is captured, as shown in operation 1010 of FIG. 9.

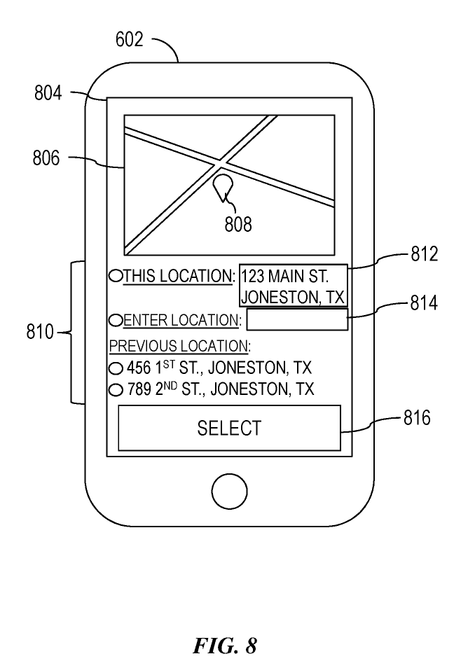

The user interface 704 further includes a navigation button 714 to transition the software program to the user interface 804 in FIG. 8. The navigation button 714 and user interface 804 enable the user to select the location of where the event leading to the report occurred. In some examples, the navigation button 714 may be greyed out until certain information has been provided through the user interface 704, such as time, date, and severity.

When the navigation button 714 has been selected, such as by clicking or tapping, the software program causes the user device 602 to transmit the cached, instantaneous location information to a mapping service 902, as shown in operation 1012 in FIG. 9. Example mapping services include Google Maps™, MapQuest™, or the like. Using Google Maps™ in this example, the software program on the user device 602 uses the Google Maps™ API to transmit location information to a server operating the Google Maps™ service. The location information can be, for example, GPS coordinates or the like. The server returns an address corresponding to the location information and data for a proximity map around the location information through the Google Maps™ API to the software program on the user device 602. Hence, the software program on the user device 602 receives the address and proximity map from the mapping service 902, as shown in operation 1014 in FIG. 9.

The user interface 804 includes the proximity map 806 that shows the position 808 on the proximity map 806 of the address received from the mapping service 902. The user interface 804 may allow a user to zoom in and/or out and/or pan the proximity map 806.

The user interface 804 also includes a location list 810 having a list of addresses with corresponding radial buttons that the user can use to select an address for the report. The location list 810 includes a field 812 populated with the address received from the mapping service 902 and shown as the position 808 on the proximity map 806, a field 814 for the user to manually enter an address, and one or more address of a previous report (such as the reports cached on the user device 602 and listed 606 in the user interface 604 of FIG. 6). In some examples, field 812 may not be editable. In some examples, an address may be entered into field 814 by selecting, such as by clicking or tapping, the field 814, and a virtual keyboard can appear on the user interface 804 for the user to use to type in an address in the field 814. The user can select the radial button of the selected address in the location list 810. Hence, the software program on the user device 602 captures an input address, as shown in operation 1016 in FIGS. 9-10.

The user interface 804 further includes a navigation button 816. When the user has selected the appropriate radial button in the location list 810, the user selects, such as by clicking or tapping, the navigation button 816. When the navigation button 816 has been selected, the software program on the user device 602 causes the user device 602 to transmit a request with the input time, date, and location information (e.g., a selected or input address and/or GPS coordinates) to a weather service 904 for weather information at the date, time, and location information of the request, as shown in operation 1018 of FIG. 10. The weather service 904 can be any weather service, such as the National Weather Service, the National Oceanic and Atmospheric Administration (NOAA), or the like. The weather service 904 can be operated on a processing system, such as included in a server device, which may be in a network, such as the network 124 of FIG. 1. In response to receiving the request, the weather service 904 processes the request and transmits weather information at the time, date, and location information to the user device 602, as shown in operation 1020 in FIG. 10. The transmission of the request and the responsive weather information may be through an API of the weather service, for example. The weather information can include, for example, conditions (e.g., sunny, partly cloudy, mostly cloudy, raining, thunderstorm, etc.), temperature, wind speed and direction (e.g., in degrees from North and/or in a cardinal direction), atmospheric pressure, the like or a combination thereof.

When the navigation button 816 has been selected, the software program on the user device 602 further captures contact information of the user, as shown in operation 1022 of FIG. 10. The contact information may be captured using an API or module on the user device 602, for example. In some instances, the user device 602 may be a telephone, such as a smart phone, and the software program on the user device 602 may access and capture a telephone number of the user device 602 from a module or API present on the user device 602. In some examples, a telephone number, email address, or other contact information of the user may be stored in memory on the user device 602 by the software program, such as during an initiation or start-up process of the software program. For example, the software program may have the user input contact information upon first using the software program, which contact information may be stored in memory on the user device 602. Other techniques for obtaining contact information may also be used.

The software program on the user device 602 caches as a report the instantaneous time, date, and location information; the input time, date, and address; any comments; the severity; weather information; and contact information, as shown in operation 1024 in FIG. 10. In some examples, more or less information may be included in the report. For example, the report can include a single location information, such as GPS coordinates or a physical address, although in some examples, both the instantaneous location information (e.g., GPS coordinates) and an input physical address are included. The software program on the user device 602 further causes the report to be transmitted to the database 906, as shown in operation 1026 in FIG. 10, and the database 906 stores the report as a report object in the database 906, as shown in operation 1028 in FIG. 10.

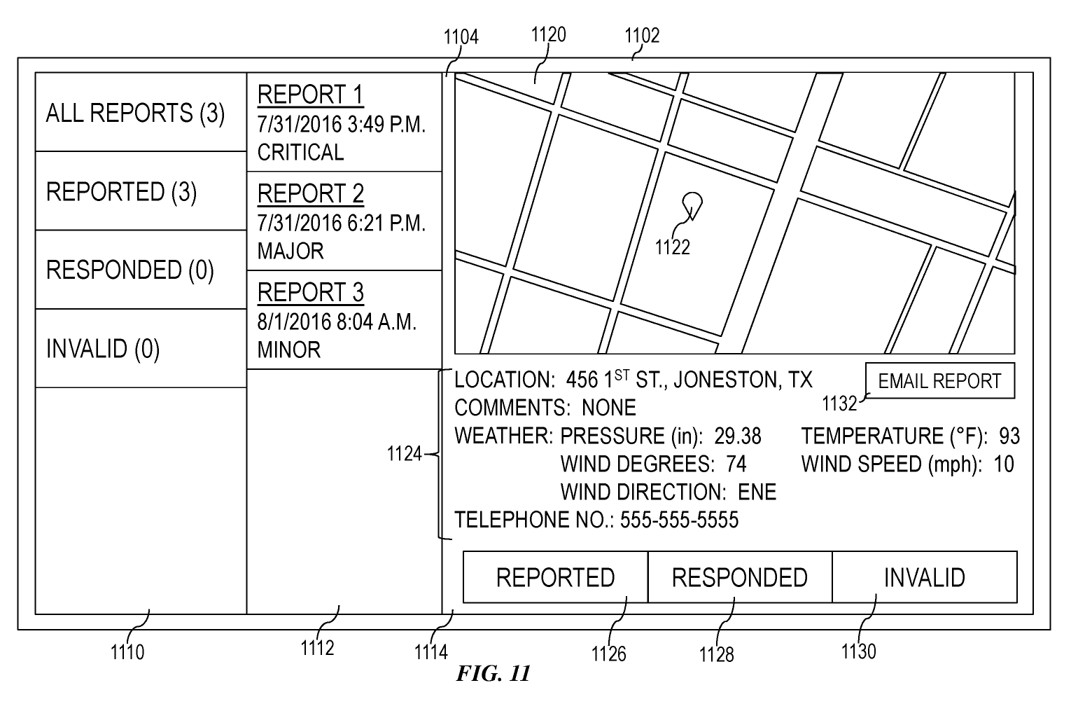

FIG. 11 is a simplified view of a user interface 1104 of a software program executed by a processing system of a back-end terminal 1102 and as appearing on a screen (which may be a touchscreen) of the back-end terminal 1102. The back-end terminal 1102 may be, for example, the back-end device 130 in FIG. 1. The software program may enable reviewing, responding to, and/or invalidating an odor report stored on a database.

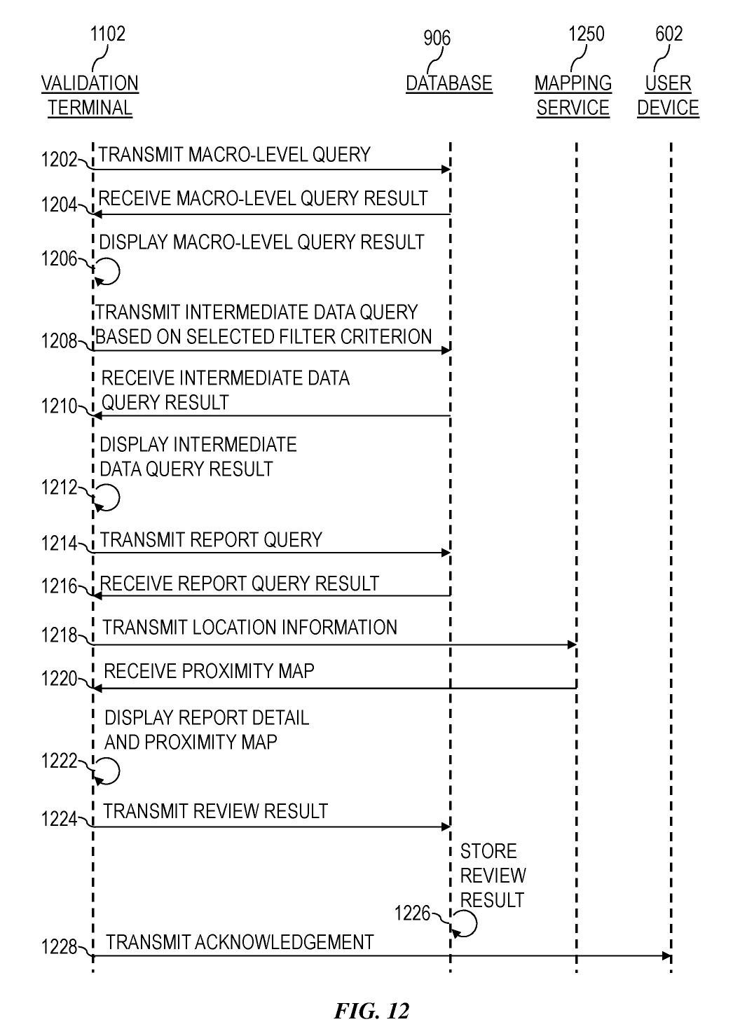

FIG. 12 is a process of operations for reviewing, responding to, and/or invalidating an odor report. The process includes operations performed by respective processing systems implementing one or more software program operating at the user device 602, a mapping service 902, the database 906 (e.g., the database maintained by the database device 128 in FIG. 1), and the back-end terminal 1102. The software program operating on the back-end terminal 1102 may be a stand-alone application, a web-based application, or the like. Various modifications to the user interface 1104 can be made, such as by including more or less information or functionality, while remaining within the scope of the present disclosure. Additionally, various modifications may be made to the process and/or operations therein while remaining within the scope of the present disclosure. For example, the process may include fewer or more operations, and may include performing various operations in a different order and/or in parallel. Communications between various devices can be by any communication technique, including wired and/or wireless communications, and may include routing communications through various components, such as may be present in a network like network 124 in FIG. 1.

The user interface 1104 in FIG. 11 includes a filter criteria pane 1110, a listing pane 1112, and a detail pane 1114. The software program on the back-end terminal 1102 causes a query for macro-level data of reports according to filter criteria to be transmitted to the database 906, as shown in operation 1202 in FIG. 12. The software program may be pre-configured, which may or may not be reconfigurable, and/or may be user configured to have filter criteria to collate various reports stored in the database 906. In the illustrated example, the filter criteria include all stored reports and review statuses, such as reported and not invalidated reports, reports to which a response has been sent and/or have been validated, and reports that have been invalidated. The database 906 transmits to the back-end terminal 1102 results responsive to the query for macro-level data of reports, as shown in operation 1204 of FIG. 12. For example, the database 906 transmits the number of all reports that are stored on the database 906, the number of reported and not invalidated reports, the number of reports to which a response has been sent and/or have been validated, and the number of reports that have been invalidated.

The software program on the back-end terminal 1102 displays the macro-level data, as shown in operation 1206 of FIG. 12. For example, in the user interface 1104 of FIG. 11, the collation and display of reports at a macro-level, for example, listing the number of reports of each review status and/or all reports, is shown in the filter criteria pane 1110. In the illustrated example, the filter criteria pane 1110 allows reports to be collated and displayed according to filter criteria into “ALL REPORTS”, “REPORTED” (e.g., reports that have been reported and not invalidated), “RESPONDED” (e.g., reports to which a response has been sent and/or have been validated), and “INVALID” (e.g., reports that have been invalidated).

The listing of filter criteria in the filter criteria pane 1110 allows a user to select which filter criterion the user desires to apply to the reports stored on the database 906. In the illustrated example, the user can select, such as by clicking or tapping, “ALL REPORTS”, “REPORTED”, “RESPONDED”, or “INVALID”. By selecting a filter criterion, the software program on the back-end terminal 1102 causes a query for intermediate data of reports responsive to the filter criterion to be transmitted to the database 906, as shown in operation 1208 in FIG. 12. The intermediate data can be a portion of data stored in each report that is responsive to the filtered criterion. In the illustrated example of FIG. 11, assuming that the user selects “REPORTED” from the filter criteria pane 1110, the back-end terminal 1102 transmits a query for intermediate data of reports that have been reported and not invalidated, and the intermediate data includes report identification, time and date (e.g., input time and date from previous description), and severity. The database 906 transmits to the back-end terminal 1102 results responsive to the query for intermediate data of reports responsive to the filter criterion, as shown in operation 1210 of FIG. 12. For example, in the example of FIG. 11, the database 906 transmits report identification, time and date, and severity of reports that have been reported and not invalidated.

The software program on the back-end terminal 1102 displays the intermediate data query result, as shown in operation 1212 of FIG. 12. For example, in the user interface 1104 of FIG. 11, a listing of reports (e.g., “REPORT 1”, “REPORT 2”, and “REPORT 3”) is shown in the listing pane 1112. In the illustrated example, the listing pane 1112 allows individual reports to be collated and displayed with the intermediate data returned from the database 906.

The listing of individual reports in the listing pane 1112 allows a user to select which report the user desires to view in the detail pane 1114. In the illustrated example, the user can select, such as by clicking or tapping, “REPORT 1”, “REPORT 2”, or “REPORT 3”. By selecting a report, the software program on the back-end terminal 1102 causes a query for the selected report to be transmitted to the database 906, as shown in operation 1214 in FIG. 12. The database 906 transmits to the back-end terminal 1102 the report responsive to the report query, as shown in operation 1216 of FIG. 12.

When the back-end terminal 1102 receives the report from the database 906, the software program on the back-end terminal 1102 extracts the location information (e.g., GPS coordinates, address, or the like) of the received report and transmits the location information to a mapping service 1250, as shown in operation 1218 in FIG. 12. Example mapping services include Google Maps™, MapQuest™, or the like. Using Google Maps™ in this example, the software program on the back-end terminal 1102 uses the Google Maps™ API to transmit the location information to a server operating the Google Maps™ service. The server returns data for a proximity map around the location information through the Google Maps™ API to the software program on the back-end terminal 1102. Hence, the software program on the back-end terminal 1102 receives the proximity map from the mapping service 1250, as shown in operation 1220 in FIG. 12.

The software program on the back-end terminal 1102 displays the selected report with detailed data and the proximity map 1120 in the detail pane 1114, as shown in operation 1222 of FIG. 12. For example, in the user interface 1104 of FIG. 11, the location information, comments, weather information, and telephone number of the report are listed in a list area 1124 and displayed in the detail pane 1114. Additionally, the proximity map 1120 with the position 1122 of the location information of the report is also shown in the detail pane 1114.

The detail pane 1114 also includes action buttons 1126, 1128, 1130 to indicate a status of the report. For example, as illustrated, a report may be stored in the database 906 with a default status of “REPORTED”. This status may indicate that the report has merely been reported without further action having been taken. The action button 1126 for “REPORTED” may be indicated as being selected by default, for example, by being a different color from other action buttons 1128, 1130. Once the report has been retrieved by the back-end terminal 1102 and reviewed by the user, the user may select, such as by clicking or tapping, one of the action buttons 1128, 1130. The user may select the action button 1128 for “RESPONDED” when the detail of the report has been reviewed and/or appears legitimate, for example. The user may select the action button 1130 for “INVALID” when some irregularity appears and/or that the report has been shown to be erroneous, for example. An example irregularity may be when frequent and embellished reports are generated from the same device with the same telephone number, which may indicate a disgruntled individual falsely reporting, for example. In some examples, when the action button 1130 for “INVALID” is selected for a report, all subsequent reports having the same telephone number as the invalidated report are also invalidated, such as by the database 906.

When the user of the back-end terminal 1102 selects an action button 1128, 1130, the software program of the back-end terminal 1102 causes a review result, which may indicate “RESPONDED” or “INVALID”, to be transmitted to the database 906, as shown by operation 1224 in FIG. 12. The database 906 stores the review result in the report object, as shown by operation 1226 in FIG. 12. Other examples can have different or more or fewer responsive actions and action buttons.

Additionally, when the user of the back-end terminal 1102 selects an action button 1128, 1130, the software program of the back-end terminal 1102 causes an acknowledgement to be transmitted to the user device 602 associated with the report, as shown by operation 1228 in FIG. 12. The acknowledgement may be a notification that the report has been received and/or processed. The acknowledgement may be transmitted as an alert through the software program of the user device 602 that was used to generate the report, in some examples. In some examples, the acknowledgement may be transmitted as a text message, email message, or the like.

The software program of the user interface 1104 may have additional functionality. For example, a button 1132 is included in the detail pane 1114 that can be selected such that the software program causes an email that contains the report to be sent to one or more person. In some examples, the proximity map 1120 may have a zoom and/or pan functionality. In some examples, the detail pane 1114 may include a button that opens another software application in which the mapping service may be accessed for further functionality.

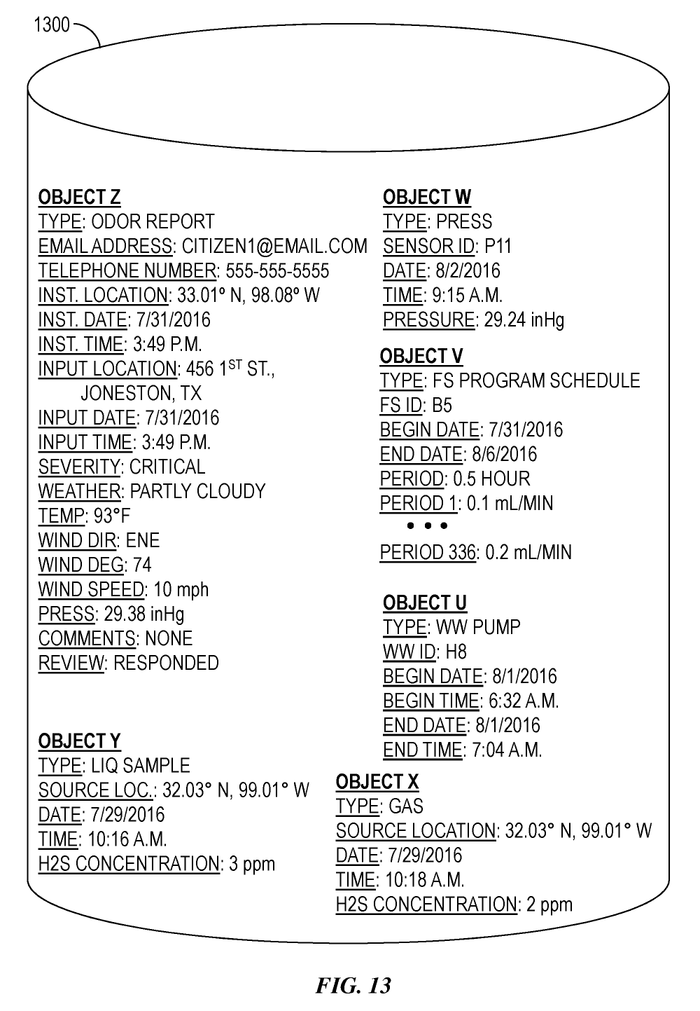

FIG. 13 illustrates some example objects that may be stored in a database 1300. These examples are for illustration, and different, more, and/or fewer objects may be used, including with different formats for stored information. Different types of objects can store different types of information. An odor report “OBJECT Z” is shown with example contact information including email address and telephone number; instantaneous location, date, and time; input location, date, and time; severity of the event giving rise to the report; weather information including weather condition, temperature, wind direction (in cardinal direction and degrees from North) and speed, and atmospheric pressure; comments from the user initiating the report; and the review result. A liquid sample “OBJECT Y” is shown with example information including the location of the liquid source in GPS coordinates, the date and time that the sample was obtained, and the result of testing for hydrogen sulfide (H₂S) concentration. An object for a liquid sample may be input by a technician after obtaining a sample of wastewater from a collection system and testing the liquid sample. A gas “OBJECT X” is shown with example information including the location of the gas testing in GPS coordinates, the date and time that the gas was tested, and the resulting concentration of H₂S in the tested gas. In some examples, a gas object can include many instances of testing at a location, which may include multiple instances of date, time, and concentration. The testing may be performed by a gas sensor deployed in the collection system for a number of days, for example, which may be retrieved and information from the sensor input into the database by a technician, for example. A pressure monitor report “OBJECT W” is shown with example information including the sensor unique identification number, the date and time that the report was made, and the pressure for the report. A feeding station program schedule “OBJECT V” is shown with example information including the feeding station unique identification number, the begin and end date of the program schedule, the duration of each period, and a rate of dispense for each period 1 through 336. A wet well pump “OBJECT U” is shown with example information including the wet well unique identification number, the begin date and time of pumping, and the end date and time of pumping. Additional objects can include, for example, information that corresponds each equipment unique identification number with a location, such as GPS coordinates, and geographical boundaries of an area of concern (e.g., geofence) for a back-end user. With objects that correspond equipment with a location, some objects that are stored based on equipment input can be mapped to a location. In some examples, a controller of various ones of deployed equipment that generate various objects (such as in feeding stations, wet wells, and pressure monitors) may have a capability to determine its location, such as using GPS position detection, and/or have its location pre-programmed to memory of the controller. The location may be incorporated in a transmission to a database that is stored in a corresponding object in the database.

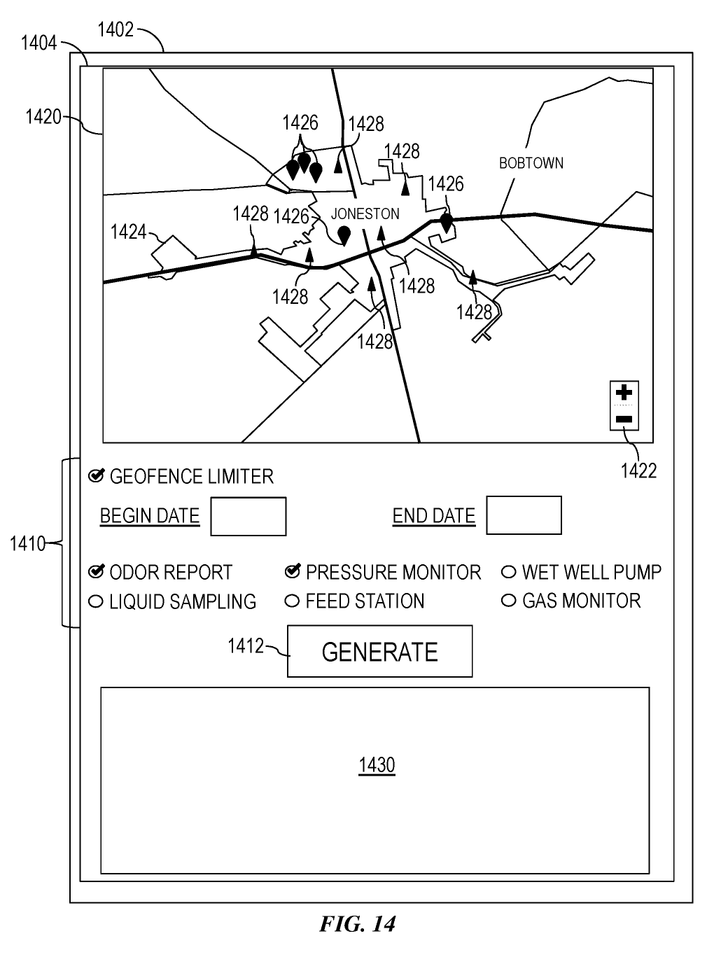

FIG. 14 is a simplified view of a user interface 1404 of a software program executed by a processing system of a back-end terminal 1402 and as appearing on a screen (which may be a touchscreen) of the back-end terminal 1402. The back-end terminal 1402 may be, for example, the back-end device 130 in FIG. 1. The back-end terminal 1402 may be the same device as the back-end terminal 1102 or a different device from the back-end terminal 1102. The software program may enable the compilation and collation of odor reports and/or other objects stored on a database.

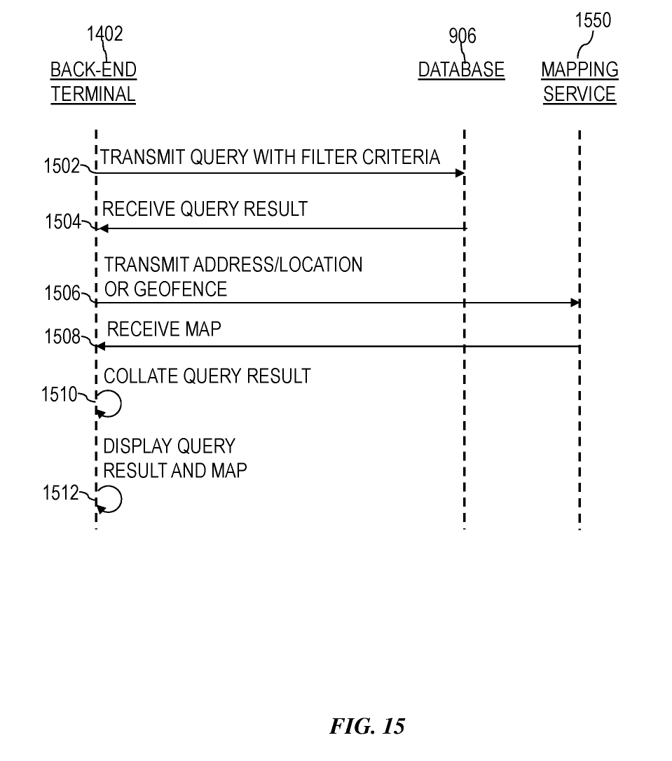

FIG. 15 is a process of operations for compiling and collating odor reports and/or other objects. The process includes operations performed by respective processing systems implementing one or more software program operating at the back-end terminal 1402 and the database 906. The software program operating on the back-end terminal 1402 may be a stand-alone application, a web-based application, or the like. Various modifications to the user interface 1404 can be made, such as by including more or less information or functionality, while remaining within the scope of the present disclosure. Additionally, various modifications may be made to the process and/or operations therein while remaining within the scope of the present disclosure. For example, the process may include fewer or more operations, and may include performing various operations in a different order and/or in parallel. Communications between various devices can be by any communication technique, including wired and/or wireless communications, and may include routing communications through various components, such as may be present in a network like network 124 in FIG. 1.

Before being able to access the user interface 1404 in FIG. 14, a user of the software program on the back-end terminal 1402 may have to log in to the software program. Credentials of the user may be stored in the database 906, and the credentials may contain permissions of the user that indicate which objects stored in the database 906 the user may or may not access. The permissions may indicate one or more object type and/or proximity of locations in objects to a predetermined location that may be accessed, for example. In some examples, the user interface 1404 may display data relating to objects that are responsive to the permissions upon the user logging in, and in some examples, the user interface 1404 may not display data relating to objects until some other action is taken.

The user interface 1404 in FIG. 14 includes a filtering selection area 1410. The filtering selection area 1410 allows a user to select one or more criteria for filtering returned objects from the database 906. Some example filtering criteria include a date range of a stored object, an object type, a geofence limiter, or the like. In the illustrated example user interface 1404, the filtering selection area 1410 includes a geofence limiter; a date range filter (with a begin date and an end date); and an object type filter (including odor report, pressure monitor, wet well pump, liquid sample, feed station, and gas monitor). The geofence limiter may be an object stored on the database 906 such that when the geofence limiter selection is indicated in the filtering selection area 1410, the object of the geofence limiter may be applied to filter responsive objects. A geofence limiter may be assigned from credentials and/or permissions of the user. The geofence limiter may be stored to the database 906 during a registration and/or installation process of the software program. The date range filter has a begin date field and an end date field. The user can enter a date into one of these fields (e.g., to have an open-ended date range), both of these fields, or none of these fields (e.g., to not apply a date filter). For example, when the user selects, such as by clicking or tapping, the begin and/or end date field, a virtual keyboard can appear on the user interface 1404 for the user to use to type in the date in the field; up/down arrows can appear to increment and decrement a default displayed date in the field; a drop-down calendar can appear for the user to select the appropriate date to be displayed in the field; a scrolling list can appear for the user to drag months, days, and years to select the appropriate date to be displayed in the field; or the like. The types of objects to be used for filtering may be selected by selecting, such as by clicking or tapping, a corresponding button of the selected type of object. In some examples, one or more filtering criteria can have filtering sub-criteria, such as, for example, an odor report can have a severity sub-criteria. In the illustrated user interface 1404, the geofence limiter, odor report objects, and pressure monitor objects have been selected as the filter criteria.

When the user of the back-end terminal 1402 has selected any filtering criteria, the user selects button 1412 for the relevant information to be displayed in the user interface 1404. When the button 1412 is selected, the software program on the back-end terminal 1402 causes a query with the selected filter criteria to be transmitted to the database 906, as shown in operation 1502 of FIG. 15. In some examples, the software program on the back-end terminal 1402 may cause the query to be sent when a filer criterion is selected without having to additionally select another button. The database 906 transmits to the back-end terminal 1402 objects (and/or data of objects) responsive to the query with the filter criteria, as shown in operation 1504 of FIG. 15.

When the back-end terminal 1402 receives the objects (and/or data of objects), the software program on the back-end terminal 1402 extracts location information from the objects (and/or data of objects), and/or if the geofence limiter filter criterion is used, receives the geofence limiter object. The software program on the back-end terminal 1402 causes the location information and/or geofence limiter object to be transmitted to a mapping service 1550, as shown in operation 1506 in FIG. 15. Example mapping services include Google Maps™ MapQuest™, or the like. Using Google Maps™ in this example, the software program on the back-end terminal 1402 uses the Google Maps™ API to transmit the location information and/or geofence limiter object to a server operating the Google Maps™ service. The server returns data for a map around the location information, or the area enclosed by the geofence limiter object, through the Google Maps™ API to the software program on the back-end terminal 1402. Hence, the software program on the back-end terminal 1402 receives the map from the mapping service 1550, as shown in operation 1508 in FIG. 15.

The user interface 1404 includes a map 1420 and a data collation area 1430. When back-end terminal 1402 receives the objects (and/or data of objects) and the map, the software program on the back-end terminal 1402 collates the objects (and/or data of objects), as shown in operation 1510 of FIG. 15, and displays the objects (and/or data of objects) and map, as shown in operation 1512 of FIG. 15. The received map is displayed as map 1420 in the user interface 1404, for example. A geographical proximity limiter 1422 is included on the map 1420. The geographical proximity limiter 1422 allows a user to zoom in and/or out to decrease and/or increase, respectively, the area around the central point of the map 1420, for example. In some examples, a geographical proximity limiter 1422 can be in the user interface 1404 and not on the map 1420. The geographical proximity limiter 1422 may be an additional filter criterion for filtering responsive objects.

Representations of the objects responsive to any filter criteria (including a geofence limiter) are displayed on the map 1420. In the illustrated map 1420, with the selection of a geofence limiter, odor report type, and pressure monitor type as the filter criteria in the filtering selection area 1410, a geofence limiter boundary 1424 (which may differ for different users) and odor report locations 1426 and pressure monitor locations 1428 within the geofence limiter boundary 1424 are displayed. Various information of different object types can be overlaid and displayed in the map 1420. Other objects and locations can be shown in other examples. Additionally, in some examples, a hover feature may be implemented with the map 1420. For example, a cursor may hover over a location of an object, such as one of the odor report locations 1426 in the illustrated example, and detailed information and/or data related to that object can be shown while the cursor hovers over the location of the object. In other examples, a user may select, by clicking or tapping, the location of an object to cause detailed information and/or data related to that object to be displayed in the map 1420.

Collated data of the responsive objects is also displayed in the data collation area 1430. In some examples, the data collation area 1430 displays data in a tabular format, and in some examples, other formats may be used for displaying information in the data collation area 1430. By displaying locations of objects in a map that may be filtered and/or displaying data collated in an area, trends and/or patterns may be more easily discerned from stored objects.

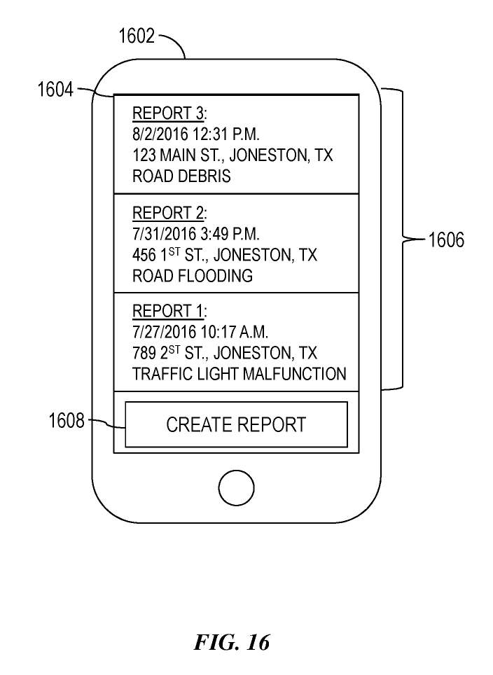

FIGS. 16-18 are simplified views of user interfaces 1604, 1704, 1804, respectively, of a software program executed by a processing system of a user device 1602 and as appearing on a screen (which may be a touchscreen) of the user device 1602. The software program may enable the generation of a report for one of a plurality of types of events. The operation of the software program on the user device 1602 is similar to the operation of the software program on the user device 602 described above in the context of FIGS. 9-10, and hence, much of the description of the operation of the software program on the user device 1602 will be omitted for brevity. Various modifications to the user interfaces 1604, 1704, 1804 can be made, such as by including more or less information or functionality, while remaining within the scope of the present disclosure. Additionally, various modifications may be made to the process and/or operations therein while remaining within the scope of the present disclosure. For example, the process may include fewer or more operations, and may include performing various operations in a different order and/or in parallel. Communications between various devices, such as between the user device 1602 and each of respective devices (e.g., server devices) operating a mapping service, weather service, and database can be by any communication technique, including wired and/or wireless communications, and may include routing communications through various components, such as may be present in a network.

The software program operating on the user device 1602 may be a stand-alone application, a web-based application, or the like. In some examples, the software program may be made available for download by one or more member of the general public as a stand-alone application through an application repository, such as the Apple App Store, Android Play Store, or the like. Other techniques for providing the software program are within the scope of the present disclosure.

In the illustrated example user interface 1604 of FIG. 16, when the software program begins operating, the user interface 1604 may appear on the screen, such as a touch screen, of the user device 1602. In this example, a list 1606 of recent reports created using the software program on the user device 1602 is shown by the user interface 1604 on the screen. The reports shown on the screen may be locally cached in memory of the user device 1602. Any number of reports may be cached and/or listed. In some examples, if more reports are listed than there is available space on the screen, the software program may allow for scrolling through the list 1606, such as by swiping up or down using a touch screen. In some examples, reports that are stored on a remote database, as will be described in further detail below, that are created using the software program on the user device 1602, and that have been overwritten in the cache on the user device 1602, for example, may be retrieved from the database when a user scrolls to the end of the list 1606. The retrieved reports can be added to the list 1606 to regenerate the list 1606, which is displayed on the user interface 1604.

In the illustrated example, details of each report on the list 1606 are shown on the list by the user interface 1604 on the screen. For example, in FIG. 16, each report has a report type, date, time, and location. In some examples, some details of each report may not be shown in the user interface at start-up. In some examples, a user may be able to select a report through the user interface 604, such as by clicking or tapping on the touch screen, which can provide another user interface on the screen that identifies one or more additional detail of the report to the user.

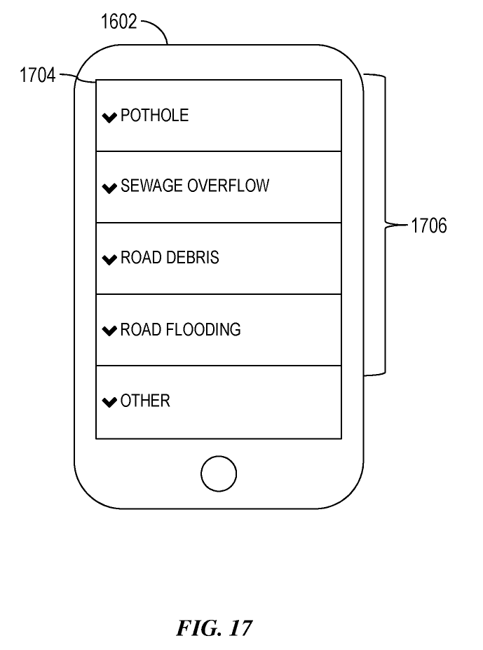

Further in the illustrated example, the user interface 1604 includes a navigation button 1608 for creating a new report. The user can select the navigation button 1608, such as by clicking or tapping on the navigation button 1608, to indicate to the software program to begin the creation of a report. When the navigation button 1608 is selected, the software program proceeds to display a different user interface 1704 on the user device 1602, as shown in FIG. 17.

Additionally, when the navigation button 1608 is selected, the software program captures and caches the instantaneous time, date, and location information, if such information is made available by the user device 1602. For example, the user device 1602 may include in its processing system a module that provides the instantaneous time and date, which may be synchronized to a given clock through a synchronization service, through an API. The software program can access the instantaneous time and date by accessing the API, and once accessed, the software program can cache the instantaneous time and date. Similarly, the user device 1602 may include in its processing system a module that provides location information, such as a GPS position, through another API. The software program can access the instantaneous location information by accessing the API, and once accessed, the software program can cache the instantaneous location information.

The user interface 1704 in FIG. 17 includes a list 1706 of expandable report types. The user may select, such as by clicking or tapping, one of the expandable report types to create a report of the selected type. In the illustrated example, report types in the list 1706 include pothole, sewage overflow, road debris, road flooding, and other, although in some examples, different, more, and/or fewer types of reports may be included, such as an odor report and a traffic light malfunction.

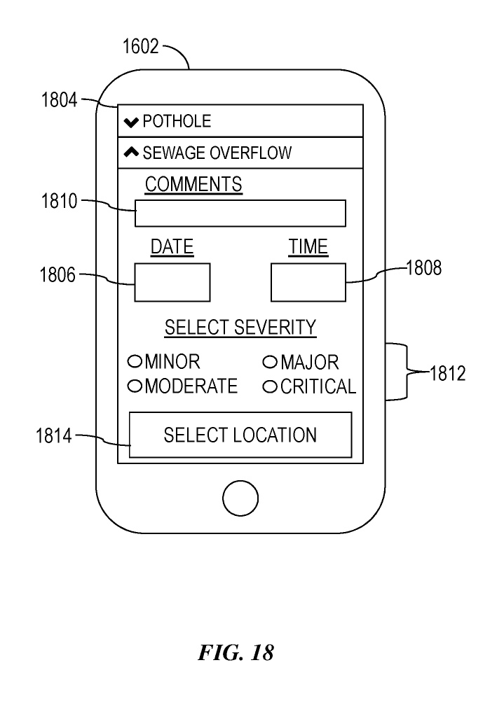

When a user selects one of the expandable report types, the selected report type expands to provide a user interface to input data for the report. As shown in the illustrated example user interface 1804 in FIG. 18, a sewage overflow report type is selected and expanded to allow the user to create a sewage overflow report. The type of information solicited by each report type can differ. As illustrated, the user interface 1804 of FIG. 18 includes, for the sewage overflow report, a date field 1806 and a time field 1808. The date field 1806 and/or time field 1808 may be populated and/or entered as described with respect to FIG. 7. Hence, the input time and date is captured, which may or may not be the instantaneous time and date.

The user interface 1804 further includes a comments field 1810. The user can enter comments, such as additional information relevant to the report, in the comments field 1810. The user may choose to not enter any comments in the comments field 1810, and in some examples, the comments field 1810 can be omitted. Accordingly, comments can be captured.

The user interface 1804 also includes a severity list 1812 with radial buttons used to select from the options in the severity list 1812. In the illustrate example, the severity list 1812 includes as options “MINOR”, “MODERATE”, “MAJOR”, and “CRITICAL”. In some examples, different or more or fewer options may be included. The radial buttons allow the user to select, such as by clicking or tapping, a radial button corresponding to an appropriate severity option that corresponds with the odor that the user is reporting. Hence, a severity is captured.

The user interface 1804 further includes a navigation button 1814 to transition the software program to the user interface 804 in FIG. 8. The navigation button 1814 and user interface 804 enable the user to select the location of where the event leading to the report occurred. In some examples, the navigation button 1814 may be greyed out until certain information has been provided through the user interface 1804, such as time, date, and severity.

As described above, when the navigation button 1814 has been selected, such as by clicking or tapping, the software program causes the user device 1602 to transmit the cached, instantaneous location information to a mapping service. An address corresponding to the location information and data for a proximity map around the location information is transmitted to the software program on the user device 1602. A subsequent user interface may be displayed on the user device 1602 for capturing an input address, similar to the user interface 804 in FIG. 8, and the input address can be captured as described above with respect to operations 1012, 1014, and 1016 of FIG. 9.

For some report types, weather information at the time and location where the event leading to report occurred may not be relevant information, and for other report types, weather information at the time and location where the event leading to report occurred may be relevant. Hence, depending on the report type, weather information may be received by the user device 1602 as described above with respect to operations 1018 and 1020 in FIG. 10. For some report types, weather information may be received, while for other report types, transmitting a request for weather information and receiving weather information may be omitted.

The software program on the user device 1602 further captures contact information of the user, as described above with respect to operation 1022 of FIG. 10. The software program on the user device 1602 caches as a report the report type, the instantaneous time, date, and location information; the input time, date, and address; any comments; contact information; and where applicable, the severity and weather information, as described above with respect to operation 1024 in FIG. 10. The software program on the user device 1602 further causes the report to be transmitted to a database, where the database stores the report as a report object corresponding to the report type, similar to what was described above with respect to operations 1026 and 1028 in FIG. 10.

Reports that are stored in the database can be reviewed and compiled using the software program(s) operating on the back-end terminal 1102 and the back-end terminal 1402 and with the operations of FIGS. 12 and 15 as described above. In some examples, modifications may be made to those examples to accommodate different report types, which would be readily apparent to one having ordinary skill in the art.

In view of the entirety of the present disclosure, including the claims and the figures, a person having ordinary skill in the art should readily recognize that the present disclosure introduces an apparatus comprising a processing system comprising a processor and a memory including computer program code. The processing system is operable to: capture an input time and an input date of an event; capture location information of the event; capture a severity of the event; capture weather information corresponding to the location information, the input time, and the input date; capture identification information of the processing system, a user of the processing system, or a combination thereof; and transmit a report to a database. The report comprises the input time, the input date, the location information, the severity, the weather information, and the identification information.

The processing system may be operable to: upon the user initiating generation of the report, cache an instantaneous time and an instantaneous date; and enable the user to enter a user-entered time and a user-entered date. The input time can be the instantaneous time or the user-entered time, and the input date can be the instantaneous date or the user-entered date.

The processing system may be operable to: upon the user initiating generation of the report, cache instantaneous location information; transmit the instantaneous location information to a mapping service; display a map and a mapping address both received from the mapping service and corresponding to the instantaneous location information; enable the user to enter a user-entered address; and enable the user to selected a stored address from one or more address of one or more cached, previously-generated report. The location information may be at least one of the instantaneous location information, the mapping address, the user-entered address, the stored address, or a combination thereof.

The processing system may be operable to capture the weather information by being operable to: transmit a request for the weather information to a weather service, the request comprising the input time, the input date, and the location information; and receive the weather information from the weather service.

The processing system may be operable to: cache a number of previously-generated reports; and display a list of the previously-generated reports.

The processing system may be operable to: enable the user to enter a comment relating to the event; and capture the comment. The report may further comprise the comment.

The processing system may be operable to generate one or more reports of a single report type.

The processing system may be operable to enable the user to select a report type from a list of a plurality of report types for generating the report.

In view of the entirety of the present disclosure, including the claims and the figures, a person having ordinary skill in the art should readily recognize that the present disclosure introduces a method comprising: operating a processing system comprising a processor and a memory including computer program code. Operating the processing system comprises: capturing an input time and an input date of an event; capturing location information of the event; capturing a severity of the event; capturing weather information corresponding to the location information, the input time, and the input date; capturing identification information of the processing system, a user of the processing system, or a combination thereof; and transmitting a report to a database. The report comprises the input time, the input date, the location information, the severity, the weather information, and the identification information.

Operating the processing system may comprise: upon the user initiating generation of the report, caching an instantaneous time and an instantaneous date; and enabling the user to enter a user-entered time and a user-entered date. The input time may be the instantaneous time or the user-entered time, and the input date may be the instantaneous date or the user-entered date.

Operating the processing system may comprise: upon the user initiating generation of the report, caching instantaneous location information; transmitting the instantaneous location information to a mapping service; displaying a map and a mapping address both received from the mapping service and corresponding to the instantaneous location information; enabling the user to enter a user-entered address; and enabling the user to selected a stored address from one or more address of one or more cached, previously-generated report. The location information may be at least one of the instantaneous location information, the mapping address, the user-entered address, the stored address, or a combination thereof.

Capturing the weather information may comprise: transmitting a request for the weather information to a weather service, the request comprising the input time, the input date, and the location information; and receiving the weather information from the weather service.

Operating the processing system may comprise: caching a number of previously-generated reports; and displaying a list of the previously-generated reports.

Operating the processing system may comprise: enabling the user to enter a comment relating to the event; and capturing the comment. The report may further comprise the comment.

The processing system may be operable to generate one or more reports of a single report type.

Operating the processing system may comprise enabling the user to select a report type from a list of a plurality of report types for generating the report.

In view of the entirety of the present disclosure, including the claims and the figures, a person having ordinary skill in the art should readily recognize that the present disclosure introduces an apparatus comprising: a processing system comprising a processor and a memory including computer program code. The processing system is operable to: cache an instantaneous time, an instantaneous date, and instantaneous location information upon initiation of generation of a report; capture an input time and an input date; transmit the instantaneous location information to a mapping service; display a map and mapping location information both received from the mapping service and corresponding to the instantaneous location information; capture input location information; capture a severity of an event giving rise to the report; transmit a request for weather information to a weather service; receive the weather information corresponding to the input time, the input date, and the input location information; capture identification information of the user, the processing system, or a combination thereof; and transmit the report. The input time is at least one of the instantaneous time, a user-entered time by a user of the processing system, or both. The input date is at least one of the instantaneous date, a user-entered date by the user, or both. The input location information is at least one of the mapping location information, a user-entered location information by the user, a stored location information, or a combination thereof. The request comprises the input time, the input date, and the input location information. The report comprises the input time, the input date, the input location information, the severity, the weather information, and the identification information.

The processing system may be operable to: enable the user to enter a comment relating to the event; and capture the comment. The report may further comprise the comment.

The processing system may be operable to generate one or more reports of a single report type.

The processing system may be operable to enable the user to select a report type from a list of a plurality of report types for generating the report.

In view of the entirety of the present disclosure, including the claims and the figures, a person having ordinary skill in the art should readily recognize that the present disclosure introduces an apparatus comprising: a processing system comprising a processor and a memory including computer program code. The processing system is operable to: enable a user to initiate generation of a report of an event; upon the user initiating generation of the report, cache an instantaneous time, an instantaneous date, and instantaneous location information; enable the user to enter a user-entered time and a user-entered date; capture an input time and an input date; capture a user-entered severity of the event; transmit the instantaneous location information to a mapping service; display a map and mapping location information both received from the mapping service and corresponding to the instantaneous location information; enable the user to enter user-entered location information; enable the user to select stored location information from one or more cached location information; capture an input location information; transmit a request for weather information to a weather service; receive the weather information corresponding to the input time, the input date, and the input location information; capture identification information of the user, the processing system, or a combination thereof; and transmit the report. The input time is the instantaneous time or the user-entered time. The input date is the instantaneous date or the user-entered date. The input location information is at least one of the instantaneous location information, the mapping location information, the user-entered location information, the stored location information, or a combination thereof. The request comprises the input time, the input date, and the input location information. The report comprises the input time, the input date, the input location information, the user-entered severity, the weather information, and the identification information.

The processing system may be operable to: enable the user to enter a comment relating to the event; and capture the comment, wherein the report further comprises the comment.

The processing system may be operable to generate one or more reports of a single report type.

The processing system may be operable to enable the user to select a report type from a list of a plurality of report types for generating the report.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to permit the reader to quickly ascertain the nature of the technical disclosure. It is submitted with the understanding that it will not be used to interpret or limit the scope or meaning of the claims.

What is claimed is:

1. An apparatus comprising:
a processing system comprising a processor and a memory including computer program code, wherein the processing system is operable to:
capture an input time and an input date of an event;
capture location information of the event;
capture a severity of the event;
capture weather information corresponding to the location information, the input time, and the input date;
capture identification information of the processing system, a user of the processing system, or a combination thereof; and
transmit a report to a database, wherein the report comprises the input time, the input date, the location information, the severity, the weather information, and the identification information.

2. The apparatus of claim 1, wherein the processing system is operable to:
upon the user initiating generation of the report, cache an instantaneous time and an instantaneous date; and
enable the user to enter a user-entered time and a user-entered date; and
wherein the input time is the instantaneous time or the user-entered time, wherein the input date is the instantaneous date or the user-entered date.

3. The apparatus of claim 1, wherein the processing system is operable to:
upon the user initiating generation of the report, cache instantaneous location information;
transmit the instantaneous location information to a mapping service;
display a map and a mapping address both received from the mapping service and corresponding to the instantaneous location information;
enable the user to enter a user-entered address; and
enable the user to selected a stored address from one or more address of one or more cached, previously-generated report; and
wherein the location information is at least one of the instantaneous location information, the mapping address, the user-entered address, the stored address, or a combination thereof.

4. The apparatus of claim 1, wherein the processing system is operable to capture the weather information by being operable to:
transmit a request for the weather information to a weather service, the request comprising the input time, the input date, and the location information; and
receive the weather information from the weather service.

5. The apparatus of claim 1, wherein the processing system is operable to:
cache a number of previously-generated reports; and
display a list of the previously-generated reports.

6. The apparatus of claim 1, wherein the processing system is operable to:
enable the user to enter a comment relating to the event; and
capture the comment, wherein the report further comprises the comment.

7. The apparatus of claim 1, wherein the processing system is operable to generate one or more reports of a single report type.

8. The apparatus of claim 1, wherein the processing system is operable to enable the user to select a report type from a list of a plurality of report types for generating the report.

9. A method comprising:
operating a processing system comprising a processor and a memory including computer program code, wherein operating the processing system comprises:
capturing an input time and an input date of an event;
capturing location information of the event;
capturing a severity of the event;
capturing weather information corresponding to the location information, the input time, and the input date;
capturing identification information of the processing system, a user of the processing system, or a combination thereof; and
transmitting a report to a database, wherein the report comprises the input time, the input date, the location information, the severity, the weather information, and the identification information.

10. The method of claim 9, wherein operating the processing system comprises:
upon the user initiating generation of the report, caching an instantaneous time and an instantaneous date; and
enabling the user to enter a user-entered time and a user-entered date; and
wherein the input time is the instantaneous time or the user-entered time, wherein the input date is the instantaneous date or the user-entered date.

11. The method of claim 9, wherein operating the processing system comprises:
upon the user initiating generation of the report, caching instantaneous location information;
transmitting the instantaneous location information to a mapping service;
displaying a map and a mapping address both received from the mapping service and corresponding to the instantaneous location information;
enabling the user to enter a user-entered address; and
enabling the user to selected a stored address from one or more address of one or more cached, previously-generated report; and
wherein the location information is at least one of the instantaneous location information, the mapping address, the user-entered address, the stored address, or a combination thereof.

12. The method of claim 9, wherein capturing the weather information comprises:
transmitting a request for the weather information to a weather service, the request comprising the input time, the input date, and the location information; and
receiving the weather information from the weather service.

13. The method of claim 9, wherein operating the processing system comprises:
caching a number of previously-generated reports; and
displaying a list of the previously-generated reports.

14. The method of claim 9, wherein operating the processing system comprises:
enabling the user to enter a comment relating to the event; and
capturing the comment, wherein the report further comprises the comment.

15. The method of claim 9, wherein the processing system is operable to generate one or more reports of a single report type.

16. The method of claim 9, wherein operating the processing system comprises enabling the user to select a report type from a list of a plurality of report types for generating the report.

17. An apparatus comprising:
a processing system comprising a processor and a memory including computer program code, wherein the processing system is operable to:
cache an instantaneous time, an instantaneous date, and instantaneous location information upon initiation of generation of a report;
capture an input time and an input date, wherein the input time is at least one of the instantaneous time, a user-entered time by a user of the processing system, or both, wherein the input date is at least one of the instantaneous date, a user-entered date by the user, or both;
transmit the instantaneous location information to a mapping service;
display a map and mapping location information both received from the mapping service and corresponding to the instantaneous location information;
capture input location information, wherein the input location information is at least one of the mapping location information, a user-entered location information by the user, a stored location information, or a combination thereof;
capture a severity of an event giving rise to the report;
transmit a request for weather information to a weather service, the request comprising the input time, the input date, and the input location information;
receive the weather information corresponding to the input time, the input date, and the input location information;
capture identification information of the user, the processing system, or a combination thereof; and
transmit the report, wherein the report comprises the input time, the input date, the input location information, the severity, the weather information, and the identification information.

18. The apparatus of claim 17, wherein the processing system is operable to:
enable the user to enter a comment relating to the event; and
capture the comment, wherein the report further comprises the comment.

19. The apparatus of claim 17, wherein the processing system is operable to generate one or more reports of a single report type.

20. The apparatus of claim 17, wherein the processing system is operable to enable the user to select a report type from a list of a plurality of report types for generating the report.
